(19) United States
(12) Patent Application Publication
(10) Pub. No.: US 2012/0239996 A1
(43) Pub. Date: Sep. 20, 2012

(54) MEMORY CONTROLLER, INFORMATION PROCESSING APPARATUS AND METHOD OF CONTROLLING MEMORY CONTROLLER

(75) Inventors: Masanori HIGETA, Kawasaki (JP); Hiroshi Nakayama, Kawasaki (JP); Hidekazu Osano, Kawasaki (JP); Hideyuki Sakamaki, Kawasaki (JP); Kazuya Takaku, Kawasaki (JP)

(73) Assignee: FUJITSU LIMITED, Kawasaki-shi (JP)

(21) Appl. No.: 13/402,284

(22) Filed: Feb. 22, 2012

(30) Foreign Application Priority Data
Mar. 20, 2011 (JP) 2011-061844

(51) Int. Cl. G06F 11/07

(52) U.S. Cl. 714/746; 714/E11.023; 714/E11.024

(57) ABSTRACT

A memory controller which is connected to a memory module having an ECC (Error Check and Correction) function and which controls access to the memory module, the memory controller, has an error detection unit configured to detect an error bit and a position of the error bit by reading, from the memory module, information on codes of the ECCs corresponding to a plurality of read data read from the memory module, a buffer configured to temporarily store the plurality of read data, and a determination unit configured to determine, when the plurality of read data stored in the buffer include a number of data in which a correctable error is detected by the error detection unit and error detection positions of the detected data are the same as each other, that a correctable error is included in a group of the plurality of read data.

### CROSS-REFERENCE TO RELATED APPLICATION

This application is based upon and claims the benefit of priority of the prior Japanese Patent Application No. 2011-061844, filed on Mar. 20, 2011, the entire contents of which are incorporated herein by reference.

### FIELD

The embodiments discussed herein are related to a memory controller and an information processing apparatus.

### BACKGROUND

As sizes of information processing apparatuses are getting larger, capacities of implemented memories are increased and high reliability is desired. Examples of a memory module having a large capacity include a DIMM (Dual Inline Memory Module). In the DIMM, a plurality of storage devices such as SDRAMs (Synchronous Dynamic Random Access Memories) are incorporated and it is highly likely that errors occur in these storage devices and transmission paths included in the DIMM. To maintain high reliability of a large-capacity memory, quick detection of a portion in which an error has been occurred in the memory is desirably performed.

A technique of detecting a memory error caused by inappropriate connection of data buses or address buses at a time when the buses are implemented on a substrate is known. As the technique of detecting a portion of a memory error, a method for adding an ECC (Error Check and Correction) code to read data has been disclosed. Use of the ECC code enables detection of errors in 2 bits or more and correction of an error in one bit, for example.

Japanese Laid-open Patent Publication Nos. 2006-269054 and 2006-260289 are examples of related art.

In a method for correcting and detecting an error in read data using a hamming code, for example, a 1-bit error of read data may be corrected but errors in 2 bits or more may not be corrected. Since an integration degree of a memory becomes higher and a memory cell in a memory chip becomes minimized, data errors in a plurality of bits which had not occurred in memories having general integration degrees occur. Therefore, capability of detection using a general ECC code is not enough and such data errors which occur in a plurality of bits may not be detected as errors.

However, when a hamming code is used, errors of read data in 3 bits or more may be mistakenly determined as a 1-bit error. As described above, when a 1-bit error occurs, the occurrence of the error is not simply notified but the 1-bit error is processed as a correctable error. However, when errors in 3 bits or more are taken into consideration, even when the errors in 3 bits or more are mistakenly determined as a 1-bit error, the errors are to be processed as uncorrectable errors.

### SUMMARY

According to an aspect of the invention, a memory controller which is connected to a memory module having an ECC (Error Check and Correction) function and which controls access to the memory module, the memory controller, has an error detection unit configured to detect an error bit and a position of the error bit by reading, from the memory module, information on codes of the ECCs corresponding to a plurality of read data read from the memory module, a buffer configured to temporarily store the plurality of read data, and a determination unit configured to determine, when the plurality of read data stored in the buffer include a number of data in which a correctable error is detected by the error detection unit and error detection positions of the detected data are the same as each other, that a correctable error is included in a group of the plurality of read data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram schematically illustrating a configuration of an information processing apparatus.

FIG. 2 is a diagram illustrating a configuration of a memory module.

FIG. 3 is a diagram illustrating a configuration of data.

FIG. 4 is a diagram illustrating an internal configuration of a memory controller included in an information processing apparatus according to a first embodiment.

FIG. 5A is a diagram illustrating an internal configuration of an ECC addition circuit included in the information processing apparatus according to the first embodiment.

FIG. 5B is a diagram illustrating a portion of an internal configuration of an ECC check circuit included in the information processing apparatus according to the first embodiment.

FIG. 6A is a diagram illustrating expressions for generating a hamming code performed by the information processing apparatus according to the first embodiment.

FIG. 6B is a diagram illustrating check result calculation values for types of error of read data in the information processing apparatus according to the first embodiment.

FIG. 7 is a diagram illustrating an internal configuration of an error collating circuit included in the information processing apparatus according to the first embodiment.

FIG. 8 is a diagram illustrating types of error pattern of a memory module and error detection patterns using a hamming code in the information processing apparatus according to the first embodiment.

FIG. 9 is a diagram illustrating an error-type determination flow performed by the information processing apparatus according to the first embodiment.

FIG. 10 is a principle diagram illustrating an operation of detecting a correctable error of read data performed by the error collating circuit included in the information processing apparatus according to the first embodiment.

FIG. 11 is a time chart illustrating the operation of detecting a correctable error of read data performed by the error collating circuit included in the information processing apparatus according to the first embodiment.

FIG. 12 is a principle diagram illustrating an operation of mistakenly detecting a correctable error of read data performed by the error collating circuit included in the information processing apparatus according to the first embodiment.

FIG. 13 is a time chart illustrating the operation of mistakenly detecting a correctable error of read data performed by the error collating circuit included in the information processing apparatus according to the first embodiment.

FIG. 14 is a principle diagram illustrating an operation of detecting an uncorrectable error of read data performed by the error collating circuit included in the information processing apparatus according to the first embodiment.

FIG. 15 is a time chart illustrating the operation of detecting an uncorrectable error of read data performed by the error collating circuit included in the information processing apparatus according to the first embodiment.

FIG. 16 is a diagram illustrating an internal configuration of a memory controller included in an information processing apparatus according to a second embodiment.

FIG. 17 is a diagram illustrating an internal configuration of an error collating circuit included in the information processing apparatus according to the second embodiment.

FIG. 18 is a table for comparing positions of error bits and SDRAM numbers in a memory module included in the information processing apparatus according to the second embodiment.

FIG. 19 is a table for comparing positions of error bits and SDRAM numbers in a memory module included in the information processing apparatus according to the second embodiment.

FIG. 20 is a diagram illustrating an error-type determination flow performed by the information processing apparatus according to the second embodiment.

FIG. 21 is a principle diagram illustrating an operation of detecting a correctable error of read data performed by the error collating circuit included in the information processing apparatus according to the second embodiment.

FIG. 22 is a time chart illustrating the operation of detecting a correctable error of read data performed by the error collating circuit included in the information processing apparatus according to the second embodiment.

FIG. 23 is a principle diagram illustrating an operation of mistakenly detecting a correctable error of read data performed by the error collating circuit included in the information processing apparatus according to the second embodiment.

FIG. 24 is a time chart illustrating the operation of mistakenly detecting a correctable error of read data performed by the error collating circuit included in the information processing apparatus according to the second embodiment.

FIG. 25 is a principle diagram illustrating an operation of detecting an uncorrectable error of read data performed by the error collating circuit included in the information processing apparatus according to the second embodiment.

FIG. 26 is a time chart illustrating the operation of detecting an uncorrectable error of read data performed by the error collating circuit included in the information processing apparatus according to the second embodiment.

### DESCRIPTION OF EMBODIMENT

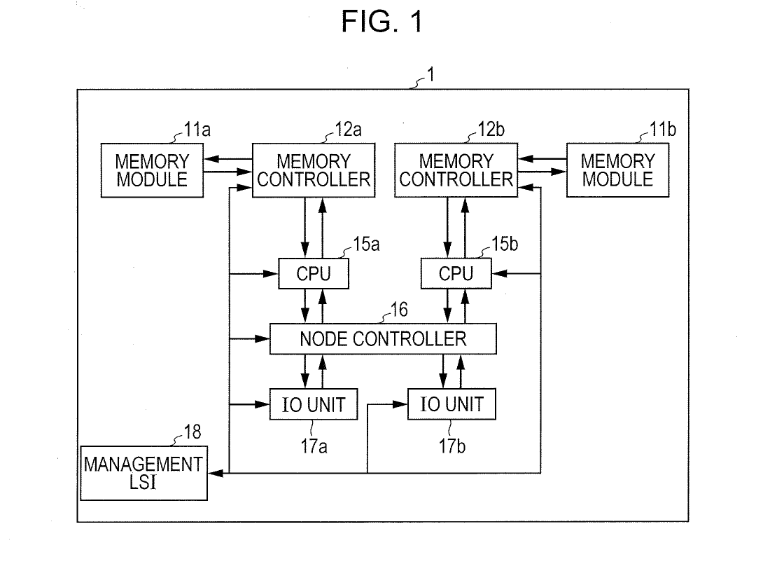

Hereinafter, embodiments will be described with reference to the accompanying drawings. FIG. 1 is a diagram schematically illustrating a configuration of an information processing apparatus. The description will be made taking a system board 1 as an example of the information processing apparatus. The system board 1 includes memory modules 11a and 11b, memory controllers 12a and 12b, CPUs (Central Processing Units) 15a and 15b, a node controller 16, IO (input/output) units 17a and 17b, and a control LSI 18.

The memory controller 12a is connected to the memory module 11a and the CPU 15a. The memory controller 12a receives a read command and a write command from the CPU 15a and performs a memory controlling on the memory module 11a.

The memory controller 12b is connected to the memory module 11b and the CPU 15b. The memory controller 12b receives a read command and a write command from the CPU 15b and performs memory control on the memory module 11b.

The node controller 16 is connected to the CPUs 15a and 15b and the IO units 17a and 17b included in the system board 1 and performs control of communication with another system board or an external information apparatus.

The control LSI 18 is connected to the circuits included in the system board 1 and monitors operation states of the circuits. Furthermore, the control LSI 18 may have a control function of maintaining the circuits in accordance with a specification defined by a user.

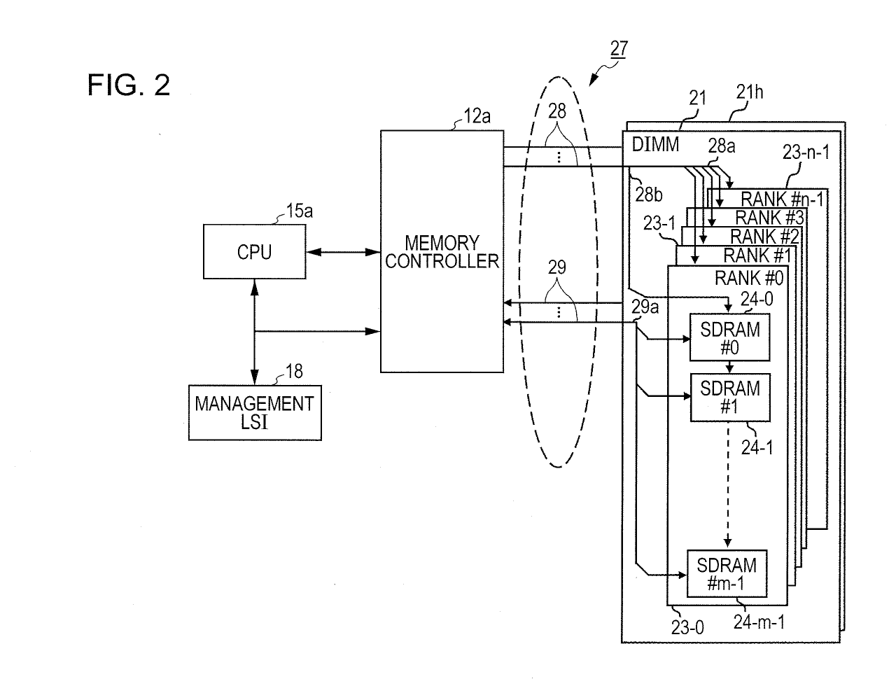

FIG. 2 is a diagram illustrating a configuration of a memory module. Examples of the memory module 11a include a DIMM (Dual Inline Memory Module). In this embodiment, the description will be made taking a large-capacity memory module including a DIMM 21 which complies with a standard DDR3 as an example. Note that the memory module 11b is configured similarly to the memory module 11a, and therefore, a description thereof is omitted.

A DIMM 21h is a spare DIMM used as a substitute when the DIMM 21 fails. The DIMM 21 includes n RANKs 23-0 to 23-n-1 (n is an integer number).

Each of the RANKs 23-0 to 23-n-1 includes a plurality of storage devices arranged in parallel. The RANK 23-0 has m SDRAMs 24-0 to 24-m-1 (m is an integer number) arranged in parallel, for example. Similarly, the DIMM 21h also includes a plurality of RANKs.

Note that, in this embodiment, since each of the memory modules 11a and 11b is managed in a unit of RANK, the RANK is used as a unit memory region in the following description. Note that, for example, when another type of memory module in which addresses thereof are managed in a unit of SDRAM is used, an SDRAM is used as a unit memory region.

When receiving a command for reading data from the DIMM 21 or a command for writing data into the DIMM 21, for example, from the CPU 15a, the memory controller 12a transmits the command and an address signal to the DIMM 21 through a command/address bus 28 included in a memory interface 27.

Then, in the DIMM 21, a chip select (CS) signal used to specify a RANK is supplied to the RANKs 23-0 to 23-n-1 through signal buses 28a. Furthermore, an inter-RANK address including a memory address (MA) and a bank address (BA) which specifies a portion in a SDRAM to be accessed is supplied to the SDRAMs 24-0 to 24-m-1 through a signal bus 28b.

Write data is transmitted through a data bus 29 and data buses 29a included in the DIMM 21 to the SDRAMs 24-0 to 24-m-1. Furthermore, read data outputted from the SDRAMs 24-0 to 24-m-1 is supplied through the data buses 29a included in the DIMM 21 and the data bus 29 included in the memory interface 27 to the memory controller 12a.

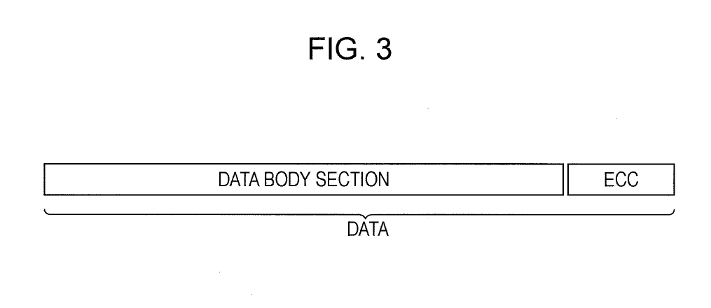

FIG. 3 is a diagram illustrating a configuration of data. As illustrated in FIG. 3, data includes an ECC (Error Check and Correction) code and a data body section. The ECC code is used to detect an error of the data and is generated as an error correction code on the basis of the data body section.

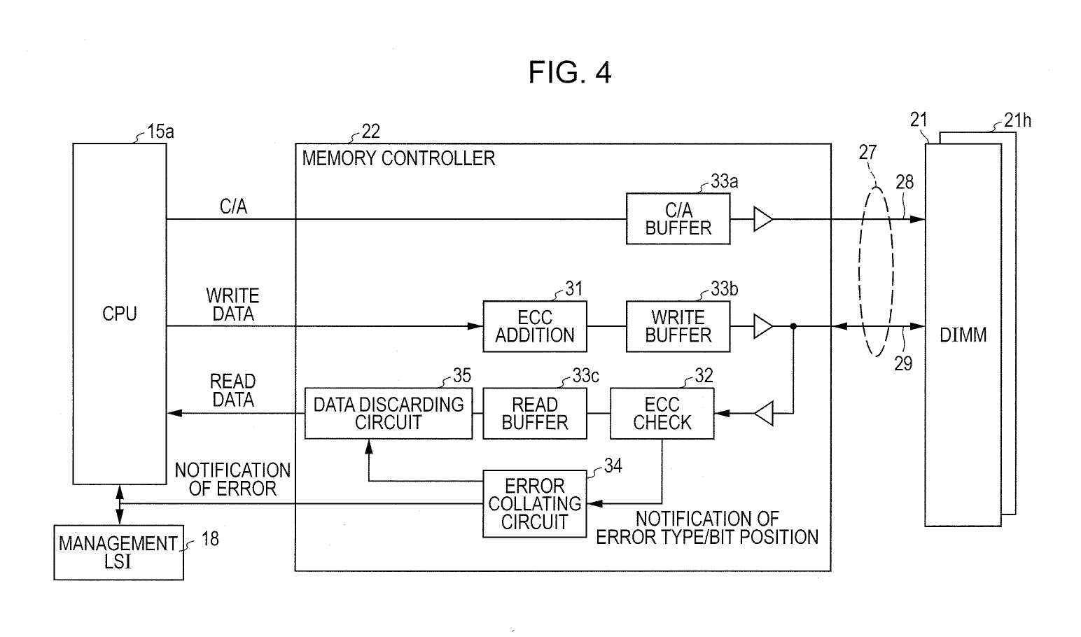

A hamming code employing a SEC/DED (Single Error Correct/Double Error Detect) method is used in the error correction code, for example. The error correction code enables detection of errors in 2 bits or more and correction of an error in one bit. When a correctable error (CE) is generated, an ECC check circuit 32 performs correction on a portion in which an error of a data bit is generated. Furthermore, simultaneously with the correction, the data is transmitted to the CPU 15a through a memory controller 22 described below with reference to FIG. 4. When an uncorrectable error (UE) is detected, a fact that an uncorrectable error is generated is transmitted by using an error signal to the CPU 15a and the control LSI 18 through the memory controller 22 described below with reference to FIG. 4.

FIG. 4 is a diagram illustrating an internal configuration of the memory controller 22 included in the information processing apparatus according to the first embodiment. The memory controller 22 illustrated in FIG. 4 is an example of the memory controller 12a illustrated in FIG. 2.

The memory controller 22 includes an ECC addition circuit 31, the ECC check circuit 32, a command/address buffer (C/A buffer) 33a, a write buffer 33b, a read buffer 33c, an error collating circuit 34, and a data discarding circuit 35.

The ECC addition circuit 31 adds an ECC code to write data transmitted from the CPU 15a.

The write buffer 33b temporarily stores the write data including the ECC code added thereto. After being temporarily stored in the write buffer 33b, the write data including the ECC code is transmitted to a specified write address included in the DIMM 21 through the data bus 29 in synchronization with a predetermined clock.

Furthermore, when receiving the write command and the address signal from the CPU 15a, the memory controller 22 temporarily stores the write command and the address signal in the C/A buffer 33a. Thereafter, the write command and the address signal are transmitted to the DIMM 21 through the command/address bus 28 in synchronization with a predetermined clock.

The read data read from the DIMM 21 is supplied to the ECC check circuit 32 through the data bus 29 in synchronization with a predetermined clock. The ECC check circuit 32 performs error detection and error correction on the read data and checks a type of error and a position of an error bit. After performing the error detection and the error correction on the read data, the ECC check circuit 32 transmits the read data to the read buffer 33c. Next, the ECC check circuit 32 transmits information on the type of error and information on the position of the error bit of the read data to the error collating circuit 34.

The read buffer 33c temporarily stores the read data supplied from the ECC check circuit 32. The read buffer 33c transmits the stored read data to the data discarding circuit 35 when the error collating circuit 34 determines the type of error which will be described hereinafter.

The error collating circuit 34 temporarily stores the information on the type of error (no error/plural-bit error/one-bit error) and the information on the position of an error bit in which an one-bit error has occurred and has been corrected. The error collating circuit 34 determines the type of error as an entire data block by checking the information on the type of error and the information on the position of an error bit which are temporarily stored therein. The error collating circuit 34 issues an instruction for discarding the data to the data discarding circuit 35 in accordance with a result of the determination of the type of error. Thereafter, the error collating circuit 34 transmits an error determination report to the CPU 15a and the control LSI 18. Specifically, the error collating circuit 34 serves as a determination unit which determines, when a plurality of read data stored in the read buffer 33c include a number of data in which a one-bit error is detected by the detection unit and error detection positions of the detected data are different from one another, that an uncorrectable error is included in a group of the plurality of read data.

The data discarding circuit 35 discards the read data transmitted form the read buffer 33c in accordance with the data discarding instruction supplied from the error collating circuit 34. The data discarding circuit 35 invalidates the read data by setting a read-data valid signal to “0”. When the error collating circuit 34 does not output the data discarding instruction, the data discarding circuit 35 transmits the read data supplied from the read buffer 33c to the CPU 15a without change.

Here, a general operation of the CPU 15a performed when the CPU 15a receives a notification of a correctable error or an uncorrectable error will be described. When receiving the notification of a correctable error, the CPU 15a including a counter which counts the number of generation of correctable errors issues an alert to the user or executes a process of switching to the spare DIMM 21h when the number becomes equal to or larger than a predetermined value. On the other hand, when receiving the notification of an uncorrectable error, the CPU 15a attempts to perform re-read on the same address in a sequence referred to as a read retry. When the error is not corrected, the CPU 15a performs a process of terminating a program or a shut down process before the read data is used so that an abnormal operation caused by the error data is avoided.

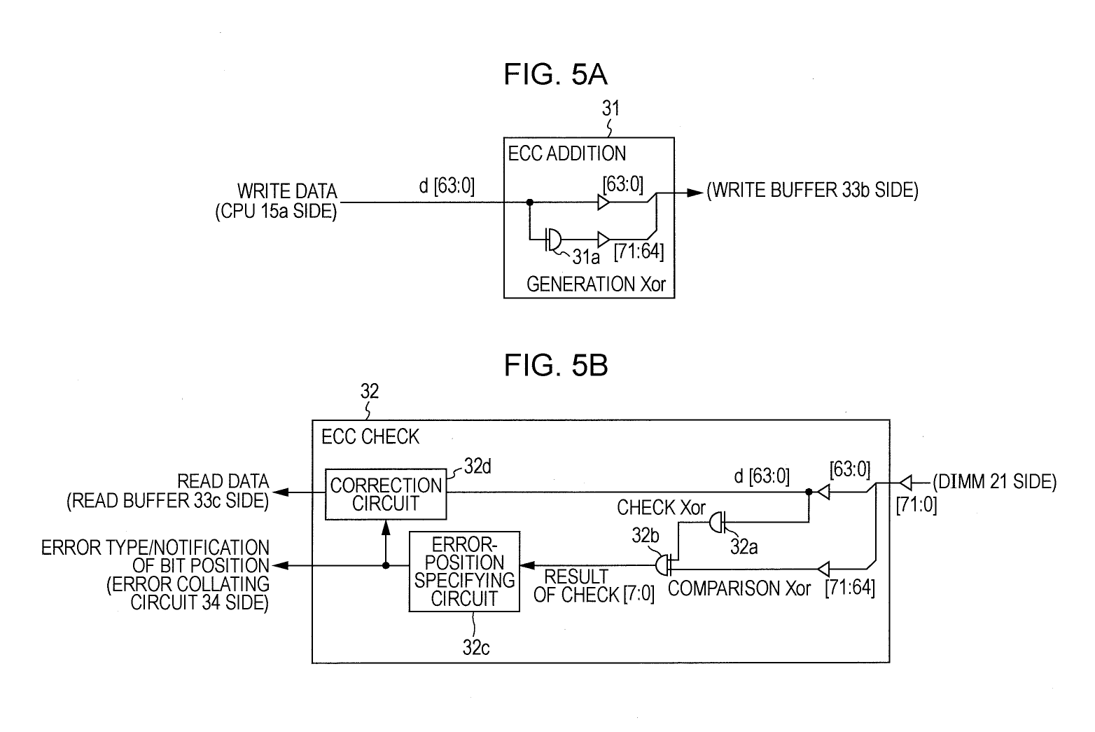

FIGS. 5A and 5B are diagrams illustrating a portion of an internal configuration of the ECC addition circuit 31 and a portion of an internal configuration of the ECC check circuit 32 which are included in the information processing apparatus according to the first embodiment. In FIGS. 5A and 5B, write data of 64 bits and read data of 64 bits are taken as examples. Note that, in FIGS. 5A and 5B, components the same as those described with reference to FIGS. 1 to 4 are denoted by reference numerals the same as those used in FIGS. 1 to 4, and descriptions thereof are omitted.

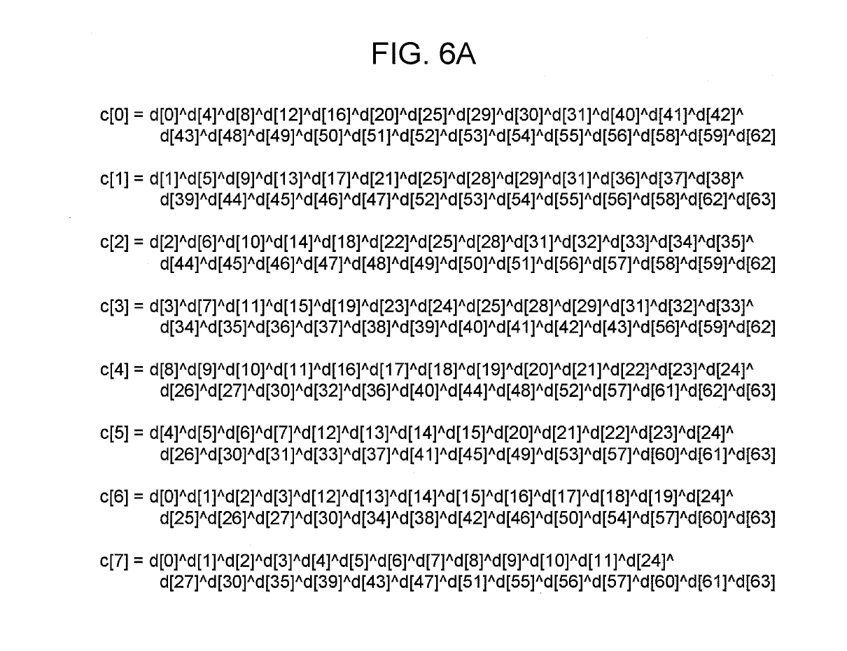

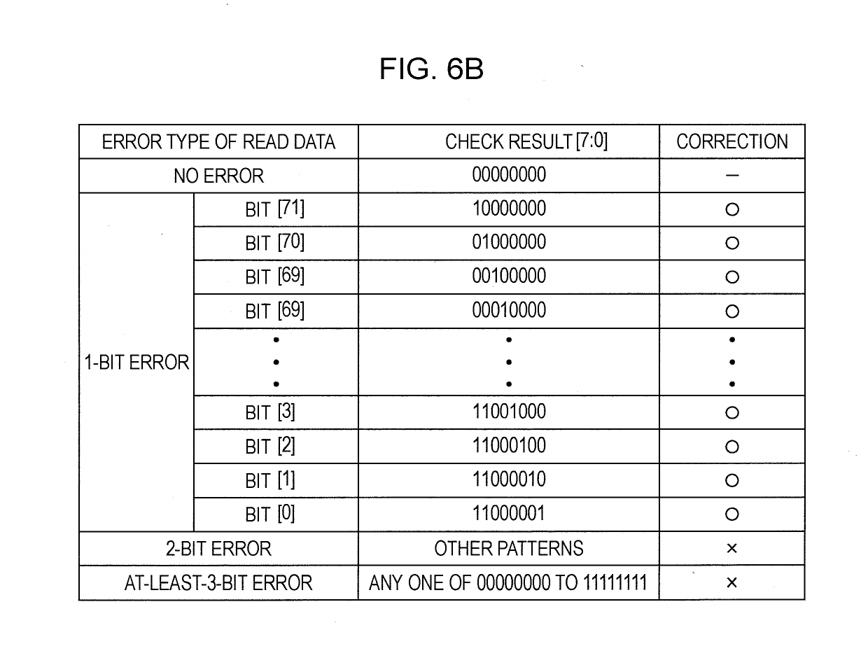

As illustrated in FIG. 5A, the ECC addition circuit 31 includes an exclusive OR circuit (generation Xor circuit) 31a. The exclusive OR circuit 31a generates an exclusive OR of 8 bits using the write data of 64 bits transmitted from the CPU 15a. The generated exclusive OR is used as a hamming code serving as an error correction code generated in accordance with the data body section. A method for generating the hamming code using the ECC addition circuit 31 will be described hereinafter with reference to FIG. 6A. Subsequently, the ECC addition circuit 31 adds the generated hamming code of 8 bits to the write data of 64 bits and transmits the write data to the write buffer 33b. Specifically, the ECC addition circuit 31 generates a hamming code for write data of several bits to be written into the memory modules 11a and 11b using the write data.

As illustrated in FIG. 5B, the ECC check circuit 32 includes an exclusive OR circuit (check Xor circuit) 32a, an exclusive OR circuit (comparison Xor circuit) 32b, an error-portion specifying circuit 32c, and a correction circuit 32d.

The exclusive OR circuit 32a obtains an exclusive OR of read data of 64 bits transmitted from the DIMM 21 and generates a hamming code used for error check of the read data. For the generation of the hamming code, a logic which is the same as that employed in the ECC addition circuit 31 is used. If an error is not included in the read data, a result of a calculation of the exclusive OR is the same as a value of the exclusive OR generated at the time of the data writing. The exclusive OR circuit 32a transmits the generated hamming code to the exclusive OR circuit 32b.

The exclusive OR circuit 32b compares the hamming code of 8 bits which is generated by the exclusive OR circuit 31a and added to the write data at the time of data writing with the hamming code of 8 bits which is generated by the exclusive OR circuit 32a. Specifically, the exclusive OR circuit 32b obtains an exclusive OR of the 8-bit hamming code which is added to the write data and the 8-bit hamming code which is generated by the exclusive OR circuit 32a. The exclusive OR circuit 32b transmits the obtained exclusive OR as a check result of 8 bits to the error-portion specifying circuit 32c.

The error-portion specifying circuit 32c specifies a type of error of the entire read data and an error portion in accordance with the 8-bit check result transmitted from the exclusive OR circuit 32b. A method for determining the type of error of the entire read data and the error portion employed in the error portion specifying circuit 32c will be described hereinafter with reference to FIG. 6B. The error-portion specifying circuit 32c transmits information on the specified type of error of the entire read data and information on the specified error portion to the correction circuit 32d and the error collating circuit 34. Specifically, the error-portion specifying circuit 32c serves as an error detection unit which detects a position of an error bit of read data which has several bits and which is read from the memory module.

The correction circuit 32d corrects the read data in accordance with the supplied information on the type of error of the entire read data and the supplied information on the error portion. The correction circuit 32d transmits the corrected read data to the read buffer 33c.

FIG. 6A is a diagram illustrating expressions for generating a hamming code performed by the information processing apparatus according to the first embodiment. As illustrated in FIG. 6A, the exclusive OR circuit 31a included in the ECC addition circuit 31 illustrated in FIG. 5A generates an 8-bit hamming code using an exclusive OR by extracting some bits from the 64-bit write data.

FIG. 6B is a diagram illustrating check result calculation values for types of error of read data in the information processing apparatus according to the first embodiment.

As illustrated in FIG. 6B, when the read data does not include an error, a check result represents a pattern of all 0. Furthermore, when a 1-bit error is included in the read data, check results do not represent a pattern of all 0 and the patterns do not coincide with one another. Therefore, the error-portion specifying circuit 32c may detect an error portion corresponding to a bit in accordance with the check result and correct the 1-bit error.

Furthermore, when a 2-bit error occurred, a check result represents a pattern other than the pattern of all 0 and the patterns of a 1-bit error. Therefore, an occurrence of a 2-bit error may be detected by analyzing the check result. However, since patterns of such check results of the 2-bit error may coincide with each other, a position of an error bit may not be specified unlikely to the case of a 1-bit error.

Furthermore, when a 3-bit error occurred, a check result represents one of patterns of two to the eight power including the pattern of all 0 and the 1-bit error patterns. Therefore when a 3-bit error occurred, it may be mistakenly determined that an error has not occurred or a 1-bit error has occurred. When a 3-bit error is mistakenly determined as a 1-bit error, a pattern of data including errors in random bits coincides with a pattern of data including a 1-bit error. Therefore, information on a position of the 1-bit error represents an arbitrary bit which does not relate to positions of the real errors.

The error collating circuit 34 of the first embodiment temporarily stores information on types of error (no error/several-bit error/1-bit error) detected in every cycle and information on positions of bits which have been subjected to 1-bit error correction. The error collating circuit 34 determines a type of an error as an entire data block by checking the information on the type of error and the information on the position of a bit which has been corrected. Since the error collating circuit 34 is additionally provided, even when the information on the position of a 1-bit error represents an arbitrary bit which does not relate to a real error position, a probability of failure of error detection and occurrence of a correction error may be reduced.

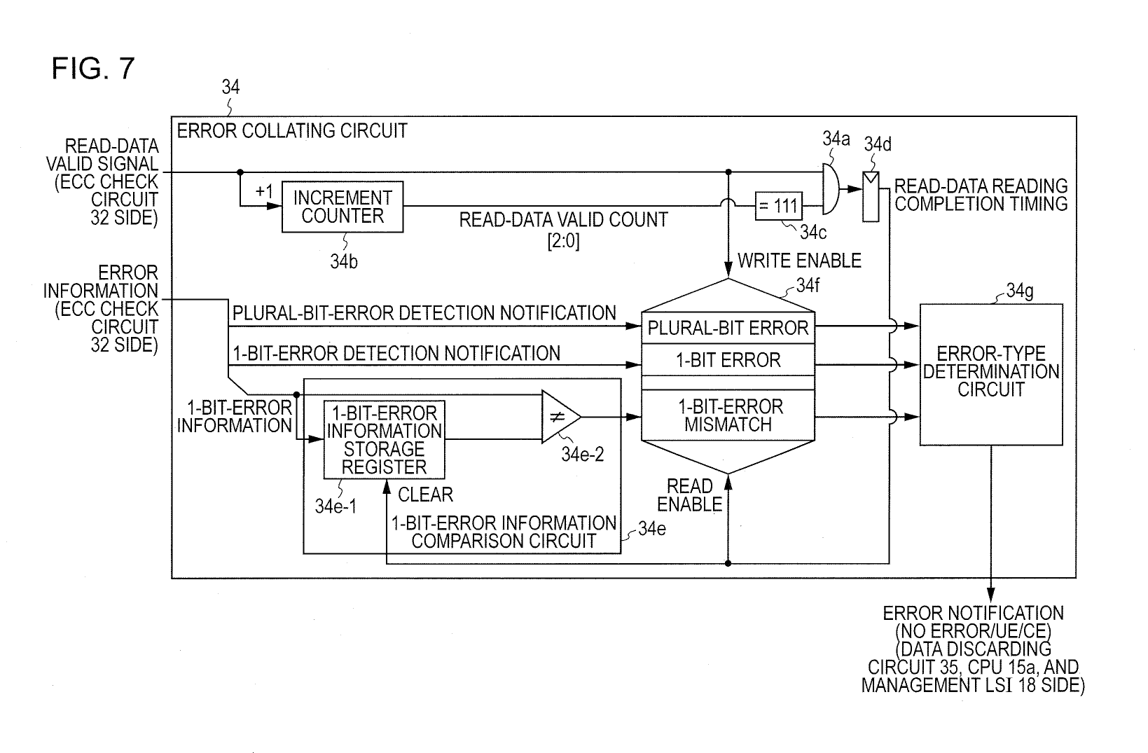

FIG. 7 is a diagram illustrating an internal configuration of the error collating circuit 34 included in the information processing apparatus according to the first embodiment. The error collating circuit 34 includes an AND circuit 34a, an increment counter 34b, a comparison circuit 34c, a flip-flop 34d, a 1-bit-error-information comparison circuit 34e, an error-information register 34f, and an error-type determination circuit 34g.

When receiving read data from the ECC check circuit 32, the AND circuit 34a detects an asserted state of a read-data valid signal. The asserted state of the signal corresponds to a high level of the signal. The read-data valid signal is in the asserted state for eight clock cycles by the ECC check circuit 32.

When receiving the read-data valid signal from the ECC check circuit 32, the increment counter 34b increments a value of a counter by one for each cycle of a clock signal and outputs the value to the comparison circuit 34c.

The increment counter 34b counts a period of the asserted state to obtain a timing when reception of the read data is completed. The comparison circuit 34c outputs “1” when the value of the increment counter 34b represents “111” or when the read-data valid signal represents “1” in the eighth time. The AND circuit 34a obtains a logical AND of the read-data valid signal and the signal outputted from the comparison circuit 34c. Thereafter, the AND circuit 34a outputs “1” to the flip-flop 34d when the read-data valid signal represents “1” in the eighth time. Specifically, the AND circuit 34a asserts a read-data-reading-completion timing signal representing that reading of the read data from the DIMM 21 is completed when the value of the counter of the increment counter 34b represents 8.

The flip-flop 34d receives a read-data-reading-completion timing signal transmitted from the AND circuit 34a. After storing the read-data valid signal supplied from the AND circuit 34a for one clock cycle, the flip-flop 34d transmits the read-data valid signal to a 1-bit-error-information storage register 34e-1 included in the 1-bit-error-information comparison circuit 34e and the error-information register 34f. The flip-flop 34d is used to delay a timing of reading from the error-information register 34f by one clock cycle and ensure performance of the reading after writing to the error-information register 34f is completed.

The 1-bit-error-information comparison circuit 34e includes the 1-bit-error-information storage register 34e-1 and a comparison circuit 34e-2.

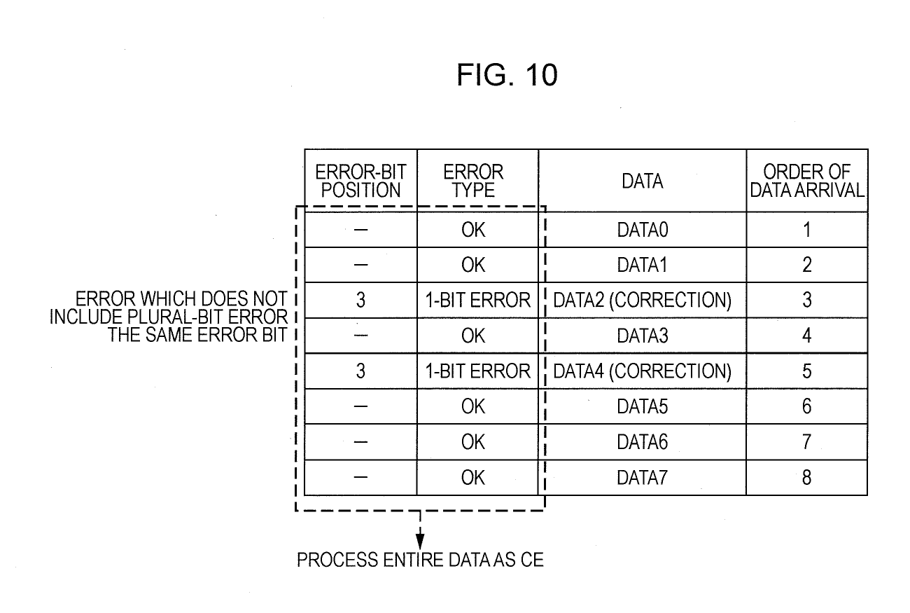

The 1-bit-error-information storage register 34e-1 temporarily stores the 1-bit-error information supplied from the ECC check circuit 32. A principle diagram of the 1-bit-error information stored in the 1-bit-error-information storage register 34e-1 will be described hereinafter with reference to FIGS. 10, 12, and 14. Note that the 1-bit-error-information storage register 34e-1 clears the 1-bit-error information when the read-data-reading-completion timing signal which represents the timing when the reading of the read data is completed is asserted by the flip-flop 34d.

The comparison circuit 34e-2 compares the 1-bit-error information supplied from the ECC check circuit 32 and the 1-bit-error information stored in the 1-bit-error-information storage register 34e-1 with each other. When the 1-bit-error information supplied from the ECC check circuit 32 does not coincide with the 1-bit-error information stored in the 1-bit-error-information storage register 34e-1, the comparison circuit 34e-2 outputs “1” to a 1-bit-error-position-mismatch detection flag “1” of the error-information register 34f. Note that when the 1-bit-error information has not been stored in the 1-bit-error-information storage register 34e-1, the comparison circuit 34e-2 does not perform the comparison between the 1-bit-error information supplied to the ECC check circuit 32 and the 1-bit-error information stored in the 1-bit-error-information storage register 34e-1.

When receiving information on detection of a plural-bit error which is transmitted for a clock cycle from the ECC check circuit 32, the error-information register 34f sets a plural-bit-error detection flag to “1”. Furthermore, when receiving information on detection of a 1-bit error which is supplied for each clock cycle from the ECC check circuit 32, the error-information register 34f sets a 1-bit-error detection flag to “1”. Moreover, when the comparison circuit 34e-2 detects the mismatch of 1-bit-error information, the error-information register 34f sets a 1-bit-error-position mismatch detection flag to “1”. Note that writing to the error-information register 34f is performed when the read-data valid signal is asserted by the ECC check circuit 32. Furthermore, reading from the error-information register 34f is performed when the read-data-reading-completion timing signal is asserted by the flip-flop 34d. Note that when reading from the error-information register 34f is performed, the plural-bit-error detection flag, the 1-bit-error detection flag, and 1-bit-error-position mismatch detection flag which are stored in the error-information register 34f are all set to “0”.

The error-type determination circuit 34g reads out the plural-bit-error detection flag information, the 1-bit-error detection flag information, and the 1-bit-error position mismatch detection flag information which are stored in the error-information register 34f when the read valid signal is asserted by the error-information register 34f. A type of error which occurred in the entire read data is determined in accordance with the plural-bit-error detection flag information, the 1-bit-error detection flag information, or the 1-bit-error position mismatch detection flag information which is outputted from the error-information register 34f. The error-type determination circuit 34g outputs error notification information to the data discarding circuit 35, the CPU 15a, and the control LSI 18 in accordance with the determined type of error. Specifically, the error-type determination circuit 34g is a determination unit which determines, when a number of data including 1-bit errors detected by the ECC check circuit 32 serving as the error detection unit are included in a plurality of read data stored in the read buffer 33c and error-detection positions of the detected data coincide with one another, that a group of the plurality of data includes a correctable error.

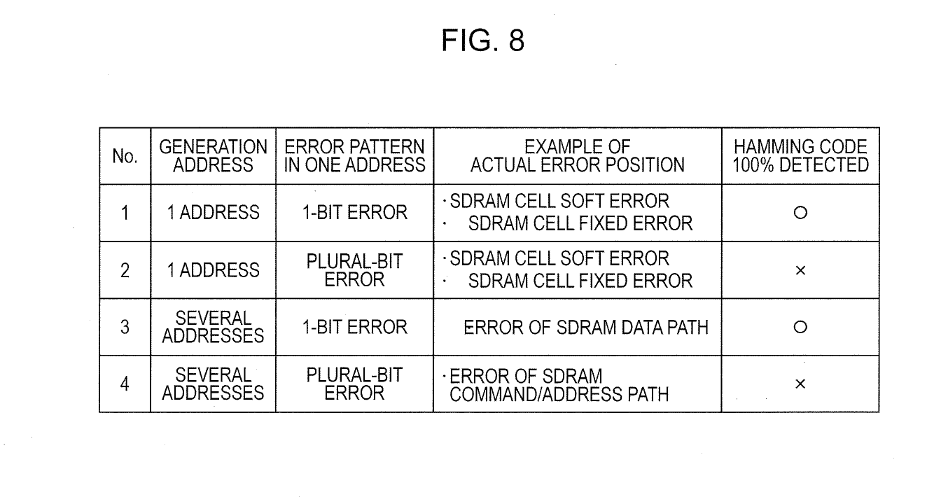

FIG. 8 is a diagram illustrating types of error pattern of the DIMM 21 which is the memory module included in the information processing apparatus according to the first embodiment and error detection patterns using a hamming code. In FIG. 8, “1 address” represents an error which occurs only in a range of one address (8-byte data) of the DIMM 21. This error is mainly caused by an error in fixing of data cells of the SDRAMs 24-0 to 24-m-1 or a soft error due to a cosmic ray. A 1-bit error illustrated in the No. 1 row is correctable using a general ECC code and therefore this error is not a problem. Furthermore, as illustrated in the No. 2 row, errors in plural bits in one address merely occur.

On the other hand, a term “several addresses” represents an error pattern in which data errors occur in a plurality of addresses in the DIMM 21. This error is mainly caused by an error of the command/address bus 28 and an error of a command/address line on a substrate included in the DIMM 21. In particular, in an SDRAM error illustrated in the No. 4 row, an error in a width of 4 bits or 8 bits may be generated in a range of a plurality of addresses, that is, an error which exceeds a detection capability of a hamming code may frequently occur. The error-type determination circuit 34g determines, when a number of data in which error bits are detected by the ECC check circuit 32 serving as the error detection unit are included in a plurality of read data in a plurality of addresses stored in the read buffer 33c and error-detection positions of the detected data coincide with one another, that a group of the plurality of data includes a correctable error. Furthermore, the error-type determination circuit 34g determines, when a number of data in which error bits are detected by the ECC check circuit 32 serving as the error detection unit are included in the read data of the plurality of addresses stored in the read buffer 33c and error-detection positions of the detected data are different from one another, that uncorrectable errors are included. With this configuration, a rate of detection of uncorrectable errors is improved.

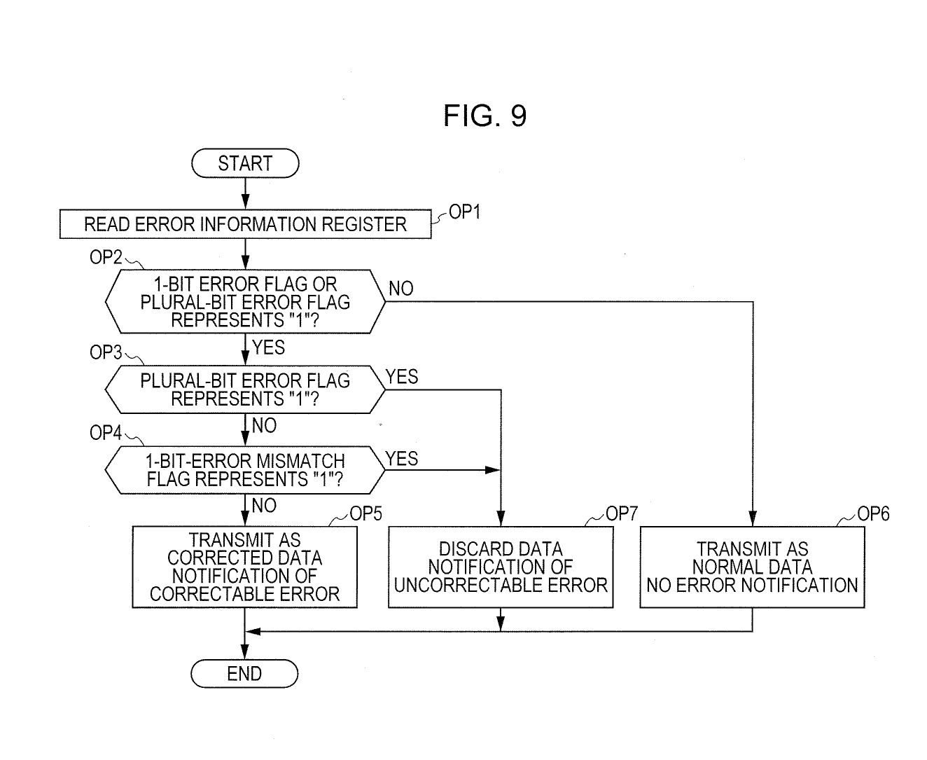

FIG. 9 is a diagram illustrating an error-type determination flow performed by the information processing apparatus according to the first embodiment. The process illustrated in FIG. 9 is executed by the error-type determination circuit 34g illustrated in FIG. 7. Note that, in FIG. 9, components the same as those described with reference to FIGS. 1 to 8 are denoted by reference numerals the same as those used in FIGS. 1 to 8, and descriptions thereof are omitted.

In FIG. 9, the error-type determination circuit 34g starts reading of the plural-bit-error detection flag information, the 1-bit-error detection flag information, and the 1-bit-error position mismatch detection flag information which are stored in the error-information register 34f from error-information register 34f when a read valid signal is asserted by the error-information register 34f (in OP1). Subsequently, the error-type determination circuit 34g determines whether the 1-bit-error detection flag or the plural-bit-error detection flag is set to “1”, that is, whether a 1-bit-error or a plural-bit error has occurred at least once (in OP2). When it is determined that the 1-bit-error detection flag or the plural-bit-error detection flag is not an on state (that is, when the determination is negative in OP2), the error-type determination circuit 34g transmits an instruction for transmitting read data stored in the read buffer 33c as normal data which does not include an error to the data discarding circuit 35 (in OP6). The error-type determination circuit 34g does not transmit an error notification to the CPU 15a and the control LSI 18 (in OP6).

When the 1-bit-error detection flag or the plural-bit-error detection flag is set to “1” (that is, the determination is affirmative in OP2), the error-type determination circuit 34g determines whether the plural-bit-error detection flag is “1” (in OP3). When it is determined that the plural-bit-error detection flag is set to “1” (that is, when the determination is affirmative in OP3), the error-type determination circuit 34g transmits an instruction for discarding the read data stored in the read buffer 33c to the data discarding circuit 35 (in OP7). The error-type determination circuit 34g notifies the CPU 15a and the control LSI 18 of a presence of an uncorrectable error in the read data stored in the read buffer 33c (in OP7).

When the plural-bit-error detection flag is not set to “1” (that is, the determination is negative in OP3), the error-type determination circuit 34g determines whether the 1-bit-error position mismatch detection flag is set to “1” (in OP4). When the 1-bit-error position mismatch detection flag is set to “1” (that is, the determination is affirmative in OP4), the error-type determination circuit 34g transmits an instruction for discarding the read data stored in the read buffer 33c to the data discarding circuit 35 (in OP7). The error-type determination circuit 34g notifies the CPU 15a and the control LSI 18 of a presence of an uncorrectable error in the read data stored in the read buffer 33c (in OP7).

When the 1-bit-error position mismatch detection flag is not set to “1” (that is, the determination is negative in OP4), the error-type determination circuit 34g transmits an instruction for transmitting the read data stored in the read buffer 33c as correction data to the data discarding circuit 35 (in OP5). The error-type determination circuit 34g notifies the CPU 15a and the control LSI 18 of a presence of a correctable error in the read data stored in the read buffer 33c (in OP5).

FIG. 10 is a principle diagram illustrating an operation of detecting a correctable error of read data performed by the information processing apparatus according to the first embodiment. Specifically, FIG. 10 is a principle diagram illustrating a case where a 1-bit error occurs due to a failure of a data line disposed on the substrate of the DIMM 21 and 1-bit errors are intermittently detected in reading in an 8-clock cycle. Error information illustrated in FIG. 10 is stored in the 1-bit-error-information storage register 34e-1, for example. As illustrated in FIG. 10, when data in one bit included in a data block of 9 bytes stored in the read buffer 33c fails, the ECC check circuit 32 detects a 1-bit error. In this case, information on a position of a correctable error represents a bit corresponding to the error data line of the SDRAMs 24-0 to 24-m-1, and therefore, results of error check of data 2 and data 4 are all “3” representing the position of the error bit. Accordingly, when the results of the error check are compared with each other and it is determined that positional information of the 1-bit errors coincide with each other, an error of a specific one bit included in a data bus of 9 bytes is recognized. The error collating circuit 34 determines this error as a correctable error. Specifically, the error collating circuit 34 is a determination unit which determines, when a number of data including 1-bit errors detected by the ECC check circuit 32 serving as the error detection unit are included in a plurality of read data stored in the read buffer 33c and error-detection positions of the detected data coincide with one another, that a group of the plurality of data includes a correctable error.

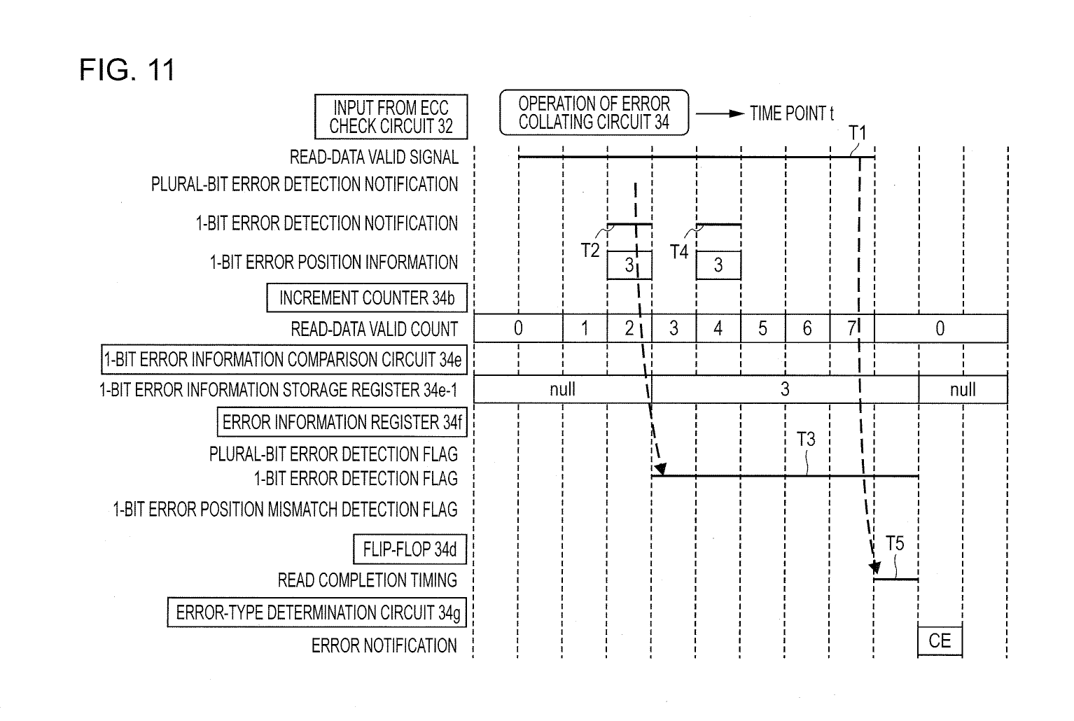

FIG. 11 is a time chart illustrating the operation of detecting a correctable error of read data performed by the error collating circuit 34.

As illustrated in FIG. 11, the AND circuit 34a receives a read-data valid signal from the ECC check circuit 32 (in a time period T1). When receiving the read-data valid signal from the ECC check circuit 32, the increment counter 34b increments a value of the counter by one for each cycle of a clock signal and outputs the value to the AND circuit 34a (in the time period T1).

The error collating circuit 34 receives a 1-bit-error detection notification and 1-bit-error position information from the ECC check circuit 32 in the third cycle in eight cycles of the read data (in a time period T2). Note that the supplied 1-bit-error position information represents that a position of a 1-bit error is “3”.

The error collating circuit 34 sets the 1-bit error detection flag of the error-information register 34f to “1” in accordance with the supplied 1-bit-error detection notification (in a time period T3).

The error collating circuit 34 receives the 1-bit-error detection notification and the 1-bit-error position information from the ECC check circuit 32 in the fifth cycle in the eight cycles of the read data (in a time period T4). Note that the supplied 1-bit-error position information represents that a position of the 1-bit error is “3”. In this case, the 1-bit-error position detected in the third cycle and the 1-bit error position detected in the fifth cycle are both “3”. Therefore, the error collating circuit 34 does not set the 1-bit-error position mismatch detection flag of the error-information register 34f to “1”.

The AND circuit 34a asserts a read-data-reading-completion timing signal representing that reading of the read data from the DIMM 21 is completed when the value of the counter of the increment counter 34b represents 7. The flip-flop 34d receives the read-data-reading-completion timing signal supplied from the AND circuit 34a (in a time period T5). Thereafter, the error-type determination circuit 34g reads the 1-bit-error detection flag information stored in the error-information register 34f. The error-type determination circuit 34g outputs error notification information representing that the error of the read data is a correctable error to the data discarding circuit 35, the CPU 15a, and the control LSI 18.

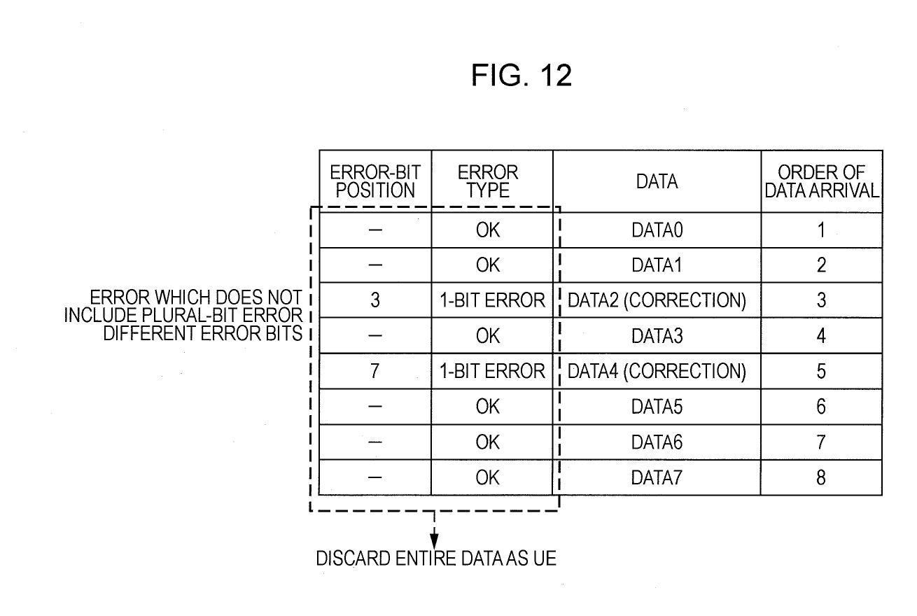

FIG. 12 is a principle diagram illustrating an operation of mistakenly detecting a correctable error of read data performed by the error collating circuit 34 included in the information processing apparatus according to the first embodiment. In FIG. 12, a case where errors intermittently occurs in 3 bits or more in 9-byte data due to a failure of an address line of the SDRAMs 24-0 to 24-m-1 in the reading operation in an 8-clock cycle and the ECC check circuit 32 mistakenly detects the errors as 1-bit errors is described as an example. As illustrated in FIG. 12, positions of the 1-bit errors in data 2 and data 4 are “3” and “7”, respectively. Therefore, when results of error check are compared with each other, the positions of the 1-bit errors do not coincide with each other. Accordingly, it is possible that errors of a plurality of bits are mistakenly detected as correctable errors. Therefore, the error collating circuit 34 of the first embodiment determines that the errors are mistakenly detected and determines the errors as uncorrectable errors. Specifically, the error-type determination circuit 34g is a determination unit which determines, when a number of data including 1-bit errors detected by the ECC check circuit 32 serving as the error detection unit are included in a plurality of read data stored in the read buffer 33c and detected error-detection positions of the data are different from each other, that correctable errors are included.

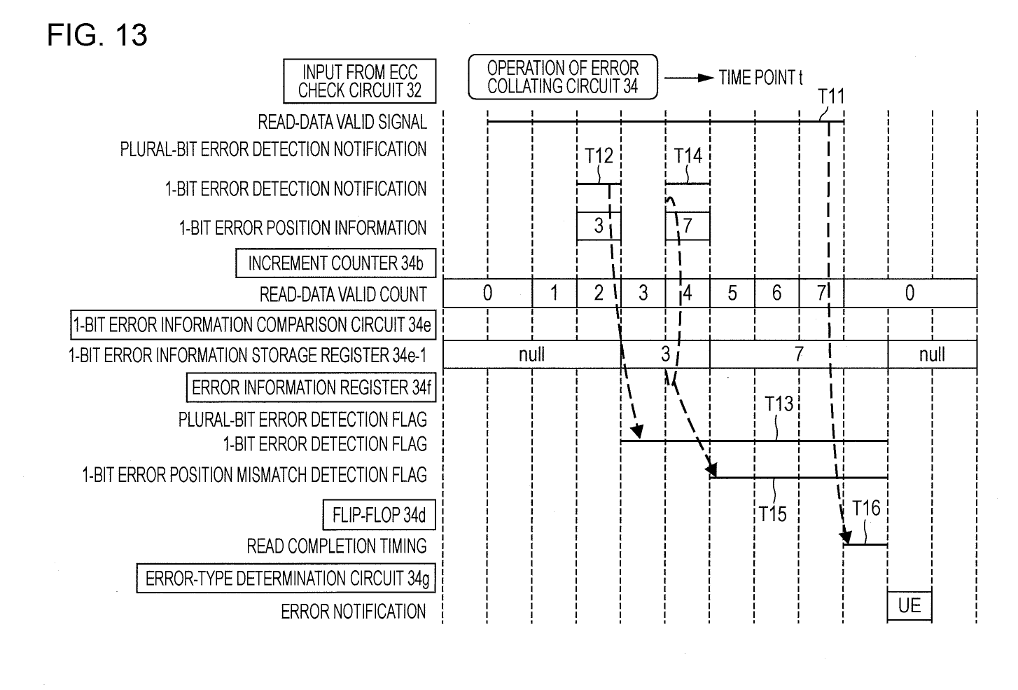

FIG. 13 is a time chart illustrating the operation of mistakenly detecting a 1-bit error of the read data performed by the error collating circuit 34.

As illustrated in FIG. 13, the AND circuit 34a receives a read-data valid signal from the ECC check circuit 32 (in a time period T11). When receiving the read-data valid signal from the ECC check circuit 32, the increment counter 34b increments a value of the counter by one for each cycle of a clock signal and outputs the value to the AND circuit 34a (in the time period T11).

The error collating circuit 34 receives a 1-bit-error detection notification and 1-bit-error position information from the ECC check circuit 32 in the third cycle in eight cycles of the read data (in a time period T12). Note that the supplied 1-bit-error position information represents that a position of the 1-bit error is “3”.

The error collating circuit 34 sets the 1-bit error detection flag of the error-information register 34f to “1” in accordance with the supplied 1-bit-error detection notification (in a time period T13).

The error collating circuit 34 receives the 1-bit-error detection notification and the 1-bit-error position information from the ECC check circuit 32 in the fifth cycle in the eight cycles of the read data (in a time period T14). Note that the supplied 1-bit-error position information represents that a position of the 1-bit error is “7”. In this case, the 1-bit-error position detected in the third cycle and the 1-bit error position detected in the fifth cycle are different from each other. Therefore, the error collating circuit 34 sets the 1-bit-error position mismatch detection flag of the error-information register 34f to “1” (in a time period T15).

The AND circuit 34a asserts a read-data-reading-completion timing signal representing that read of the read data from the DIMM 21 is completed when the value of the counter of the increment counter 34b represents 7. The flip-flop 34d receives the read-data-reading-completion timing signal supplied from the AND circuit 34a (in a time period T16). Thereafter, the error-type determination circuit 34g reads the 1-bit-error detection flag information and the 1-bit-error position mismatch detection flag information which are stored in the error-information register 34f. The error-type determination circuit 34g outputs error notification information representing that the error of the read data is an uncorrectable error to the data discarding circuit 35, the CPU 15a, and the control LSI 18.

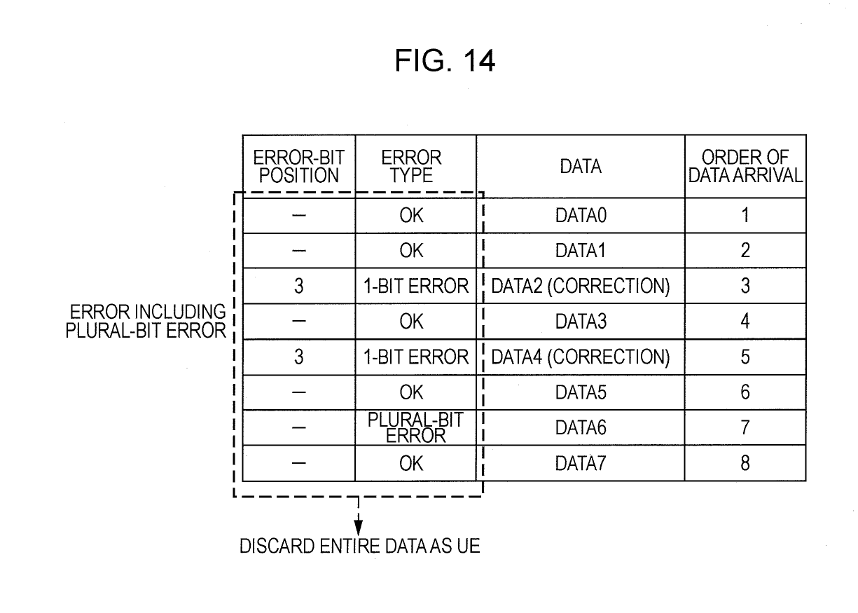

FIG. 14 is a principle diagram illustrating an operation of detecting a plural-bit error of read data performed by the error collating circuit 34 included in the information processing apparatus according to the first embodiment. In FIG. 14, a case where errors intermittently occurs in 2 bits or more in 9-byte data due to a failure of an address line of the SDRAMs 24-0 to 24-m-1 in the reading operation in a 8-clock cycle and the ECC check circuit 32 detects an uncorrectable error is described as an example. As illustrated in FIG. 14, positions of the 1-bit errors in data 2 and data 4 are “3”, and data 6 includes a plural-bit error. In this case, it is apparent that errors occur in a plurality of bits in the DIMM 21 since the plural-bit error is detected, and accordingly, the error collating circuit 34 determines the error as an uncorrectable error.

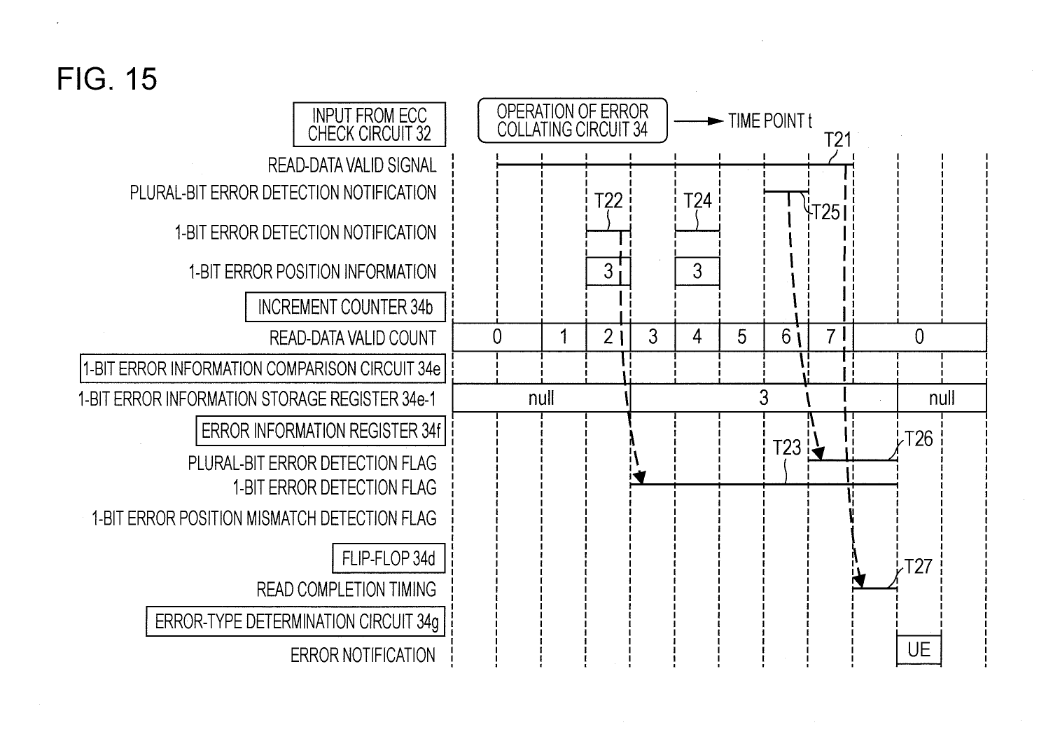

FIG. 15 is a time chart illustrating an operation of detecting an uncorrectable error of read data performed by the error collating circuit 34.

As illustrated in FIG. 15, the AND circuit 34a receives a read-data valid signal from the ECC check circuit 32 (in a time period T21). When receiving the read-data valid signal from the ECC check circuit 32, the increment counter 34b increments a value of the counter by one for each cycle of a clock signal and outputs the value to the AND circuit 34a (in the time period T21).

The error collating circuit 34 receives a 1-bit-error detection notification and 1-bit-error position information from the ECC check circuit 32 in the third cycle in eight cycles of the read data (in a time period T22). Note that the supplied 1-bit-error position information represents that a position of the 1-bit error is “3”.

The error collating circuit 34 sets the 1-bit error detection flag of the error-information register 34f to “1” in accordance with the supplied the 1-bit-error detection notification (at a time period T23).

The error collating circuit 34 receives the 1-bit-error detection notification and the 1-bit-error position information from the ECC check circuit 32 in the fifth cycle in the eight cycles of the read data (in a time period T24). Note that the supplied 1-bit-error position information represents that a position of the 1-bit error is “3”. In this case, the 1-bit-error position detected in the third cycle and the 1-bit error position detected in the fifth cycle are the same as each other. Therefore, the error collating circuit 34 does not set the 1-bit-error position mismatch detection flag of the error-information register 34f to “1”.

The error collating circuit 34 receives a plural-bit-error detection notification from the ECC check circuit 32 in the seventh cycle in the eight cycles of the read data (in a time period T25). The error collating circuit 34 sets the plural-bit-error position mismatch detection flag of the error-information register 34f to “1” (in a time period T26).

The AND circuit 34a asserts a read-data-reading-completion timing signal representing that read of the read data from the DIMM 21 is completed when the value of the counter of the increment counter 34b represents 7. The flip-flop 34d receives the read-data-reading-completion timing signal supplied from the AND circuit 34a (in a time period T27). Thereafter, the error-type determination circuit 34g reads out the 1-bit-error detection flag information and the plural-bit-error detection flag information which are stored in the error-information register 34f. The error-type determination circuit 34g outputs error notification information representing that the error of the read data is an uncorrectable error to the data discarding circuit 35, the CPU 15a, and the control LSI 18.

Since the memory controller 22 is used in the first embodiment, even when errors occur in a plurality of bits, probability of occurrence of failure of error detection may be considerably reduced. For example, when probability of a case where an SDRAM fails in an x4DIMM having 18 SDRAMs is calculated, the probability of the failure of error detection is approximately 5.9% when a general method for checking whether an error has occurred every 72 bits and sequentially transmitting a result of the check is employed whereas the probability of the failure of error detection is reduced to approximately 0.0079% when the memory controller 22 of the first embodiment is used.

According to the technique disclosed in the first embodiment, when a data error which exceeds capability of an error correction code of the memory controller 22 occurs and therefore failure of error detection and a correction error occur, the error may be corrected and notification of the error may be performed. Furthermore, supply of data to be discarded through the error check circuit may be suppressed. Accordingly, continuous operation of the system using inappropriate data is suppressed, and consequently, reliability of the information processing apparatus may be improved.

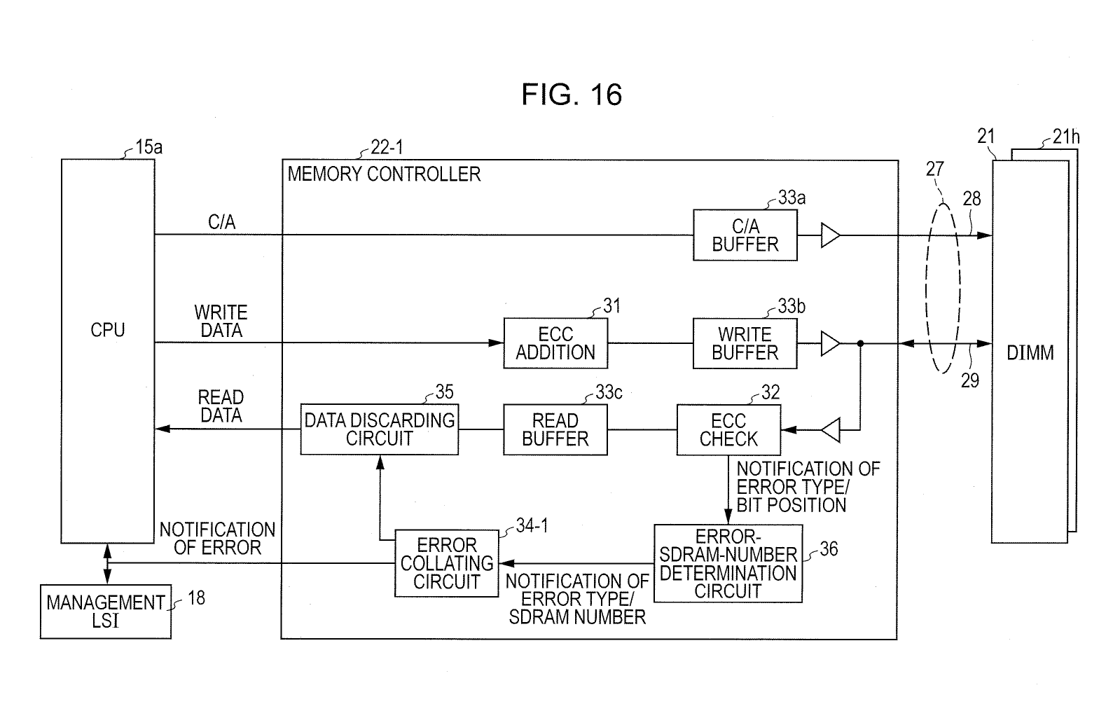

FIG. 16 is a diagram illustrating an internal configuration of a memory controller 22-1 included in an information processing apparatus according to a second embodiment. In FIG. 16, the memory controller 22-1 is an example of the memory controller 12a illustrated in FIG. 2. Note that, in FIG. 16, components the same as those described with reference to FIGS. 1 to 4 of the first embodiment are denoted by reference numerals the same as those used in FIGS. 1 to 4, and descriptions thereof are omitted.

Although, in the memory controller 22 and the information processing apparatus according to the first embodiment, a position where an error has occurred is managed by a bit number of data [71:0] in the DIMM 21 as a 1-bit error, the position where an error has occurred may be represented by various manners. The memory controller 22-1 and the information processing apparatus in the second embodiment individually manage error positions of the SDRAMs 24-0 to 24-m-1 and numbers of the SDRAMs 24-0 to 24-m-1 in a DIMM 21 may be used as information on positions of 1-bit errors.

The memory controller 22-1 includes an ECC addition circuit 31, an ECC check circuit 32, a command/address buffer (C/A buffer) 33a, a write buffer 33b, a read buffer 33c, an error collating circuit 34-1, a data discarding circuit 35, and an error-SDRAM-number determination circuit 36.

When the ECC check circuit 32 outputs information on a type of error and information on a position of an error bit, the error-SDRAM-number determination circuit 36 determines and outputs a number of an SDRAM including the error bit in accordance with the error-bit position information.

The error collating circuit 34-1 temporarily stores the information on a type of error (no error/plural-bit error/one-bit error) and the number of SDRAM including the error bit in which an one-bit error has occurred and corrected. The error collating circuit 34-1 determines the type of error as an entire data block by checking the information on a type of error and the SDRAM number which are temporarily stored therein. The error collating circuit 34-1 issues an instruction for discarding the data to the data discarding circuit 35 in accordance with a result of the determination of the type of error. Thereafter, the error collating circuit 34-1 transmits an error determination report to a CPU 15a and a control LSI 18. Specifically, the error collating circuit 34-1 is a determination unit which determines, when a number of data including 1-bit errors detected by the ECC check circuit 32 serving as the error detection unit are included in a plurality of read data stored in the read buffer 33c and error-detection positions of the detected data are different from one another or when data from which a plural-bit error is detected is included, that uncorrectable errors are included in the plurality of read data as a whole.

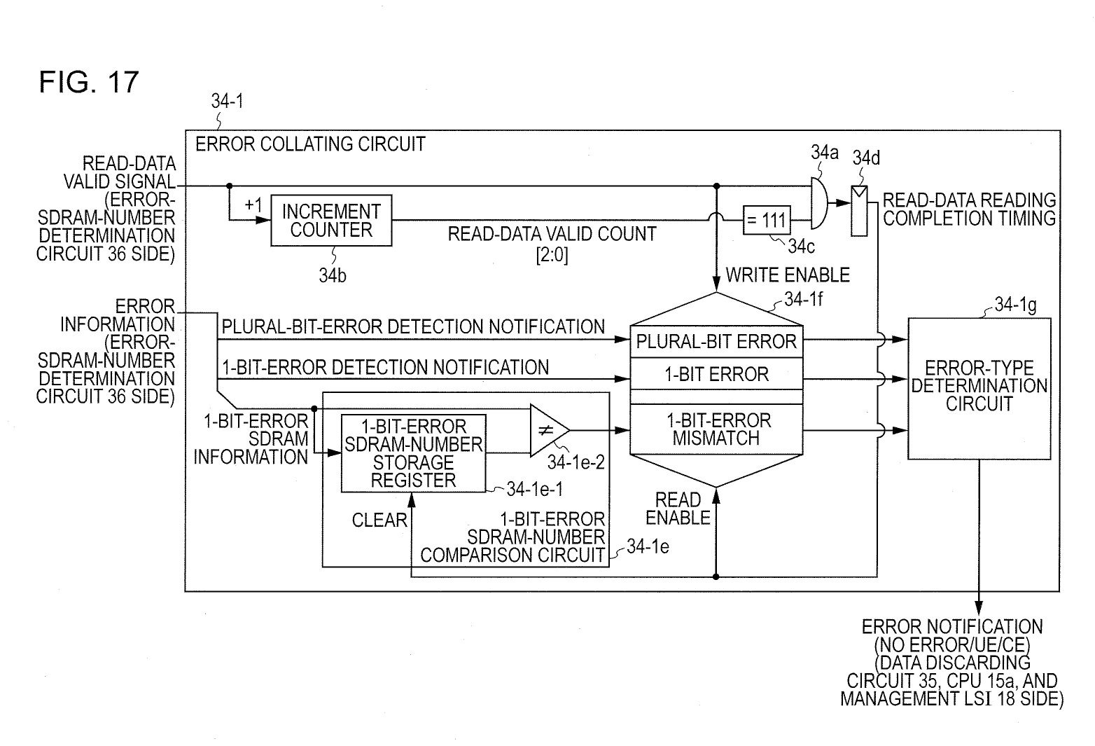

FIG. 17 is a diagram illustrating an internal configuration of the error collating circuit 34-1 included in the information processing apparatus according to the second embodiment. The error collating circuit 34-1 includes an AND circuit 34a, an increment counter 34b, a comparison circuit 34c, a flip-flop 34d, a 1-bit-error-SDRAM-number comparison circuit 34-1e, an error-information register 34-1f, and an error-type determination circuit 34-1g.

The 1-bit-error-SDRAM-number comparison circuit 34-1e includes a 1-bit-error-SDRAM-number storage register 34-1e-1 and a comparison circuit 34-1e-2.

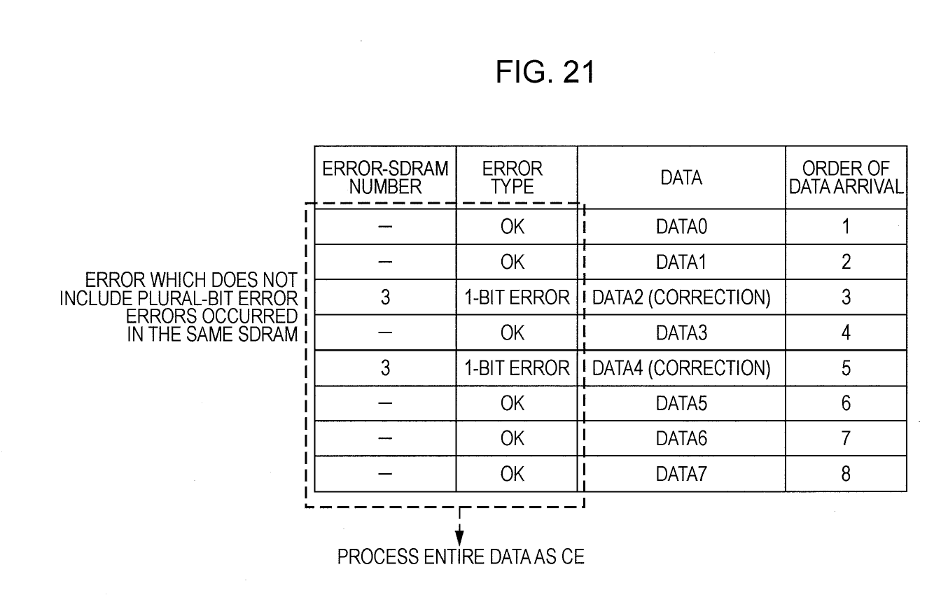

The 1-bit-error-SDRAM-number storage register 34-1e-1 temporarily stores a 1-bit-error SDRAM number supplied from the error-SDRAM-number determination circuit 36. A principle diagram of the 1-bit-error SDRAM number information stored in the 1-bit-error-SDRAM-number storage register 34-1e-1 will be described hereinafter with reference to FIGS. 21, 23, and 25. Note that the 1-bit-error-SDRAM-number storage register 34-1e-1 clears 1-bit-error information when a read-data-reading-completion timing signal which represents a timing when reading of read data is completed is asserted by the flip-flop 34d.

The comparison circuit 34-1e-2 compares information on a 1-bit-error SDRAM number supplied from the error-SDRAM-number determination circuit 36 and the information on the 1-bit-error SDRAM number stored in the 1-bit-error-SDRAM-number storage register 34-1e-1 with each other. When the information on the 1-bit-error SDRAM number supplied from the error-SDRAM-number determination circuit 36 does not coincide with the information on the 1-bit-error SDRAM number stored in the 1-bit-error-SDRAM-number storage register 34-1e-1, the comparison circuit 34-1e-2 outputs “1” to a 1-bit-error-SDRAM-number mismatch detection flag of the error-information register 34-1f. Note that when the information on the 1-bit-error SDRAM number has not been stored in the 1-bit-error-SDRAM-number storage register 34-1e-1, the comparison circuit 34-1e-2 does not perform the comparison between the information on the 1-bit-error SDRAM number supplied from the error-SDRAM-number determination circuit 36 and the information on the 1-bit-error SDRAM number stored in the 1-bit-error-SDRAM-number storage register 34-1e-1.

When receiving information on detection of a plural-bit error which is transmitted for each clock cycle from the error-SDRAM-number determination circuit 36, the error-information register 34-1f sets a plural-bit-error detection flag to “1”. Furthermore, when receiving information on detection of a 1-bit error which is transmitted for each clock cycle from the error-SDRAM-number determination circuit 36, the error-information register 34-1f sets a 1-bit-error detection flag to “1”. Moreover, when the comparison circuit 34-1e-2 detects mismatch of 1-bit-error SDRAM numbers, the error-information register 34-1f sets a 1-bit-error-SDRAM-number mismatch detection flag to “1”. Note that writing to the error-information register 34-1f is performed when a read-data valid signal is asserted by the ECC check circuit 32. Furthermore, reading from the error-information register 34-1f is performed when a read-data-reading-completion timing signal is asserted by the flip-flop 34d and supplied to the error-information register 34-1f. Note that when reading from the error-information register 34-1f is performed, the plural-bit-error detection flag, the 1-bit-error detection flag, and 1-bit-error-SDRAM-number mismatch detection flag which are stored in the error-information register 34-1f are all set to “0”.

The error-type determination circuit 34-1g reads out the plural-bit-error detection flag information, the 1-bit-error detection flag information, and the 1-bit-error-SDRAM-number mismatch detection flag information which are stored in the error-information register 34-1f when a read valid signal is asserted by the error-information register 34-1f. A type of an error which has occurred in the entire read data is determined in accordance with the plural-bit-error detection flag information, the 1-bit-error detection flag information, and the 1-bit-error-SDRAM-number mismatch detection flag information which are outputted from the error-information register 34-1f. The error-type determination circuit 34-1g outputs error notification information to the data discarding circuit 35, the CPU 15a, and the control LSI 18 in accordance with the determined type of error. Specifically, the error-type determination circuit 34-1g is a determination unit which determines, when a number of data including 1-bit errors detected by the ECC check circuit 32 serving as the error detection unit are included in a plurality of read data stored in the read buffer 33c and error-detection positions of the detected data coincide with one another, that a group of the plurality of data includes a correctable error.

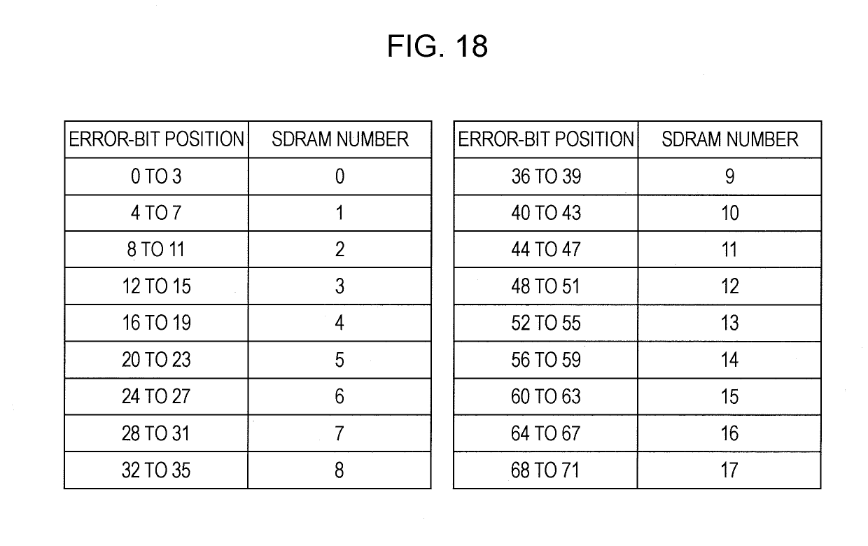

FIG. 18 is a table for comparing positions of error bits and SDRAM numbers in a DIMM serving as a memory module included in the information processing apparatus according to the second embodiment. In FIG. 18, the table is used to compare positions of error bits and SDRAM numbers in a x4DIMM having 18 SDRAMs 24-0 to 24-17. Each of the SDRAMs illustrated in FIG. 18 stores 4-bit data. Therefore, an error-bit position corresponding to an SDRAM number 0 is set to a range from 0 to 3.

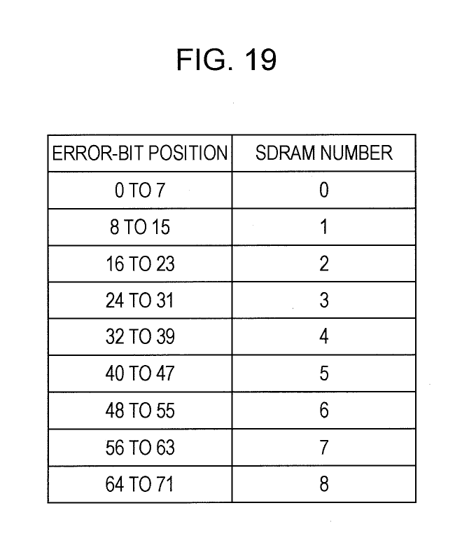

FIG. 19 is a table for comparing positions of error bits and SDRAM numbers in a DIMM serving as a memory module included in the information processing apparatus according to the second embodiment. In FIG. 19, the table is used to compare positions of error bits and SDRAM numbers in an x8DIMM having 9 SDRAMs 24-0 to 24-8. Each of the SDRAMs illustrated in FIG. 19 stores 8-bit data. Therefore, an error-bit position corresponding to an SDRAM number 0 is set to a range from 0 to 7.

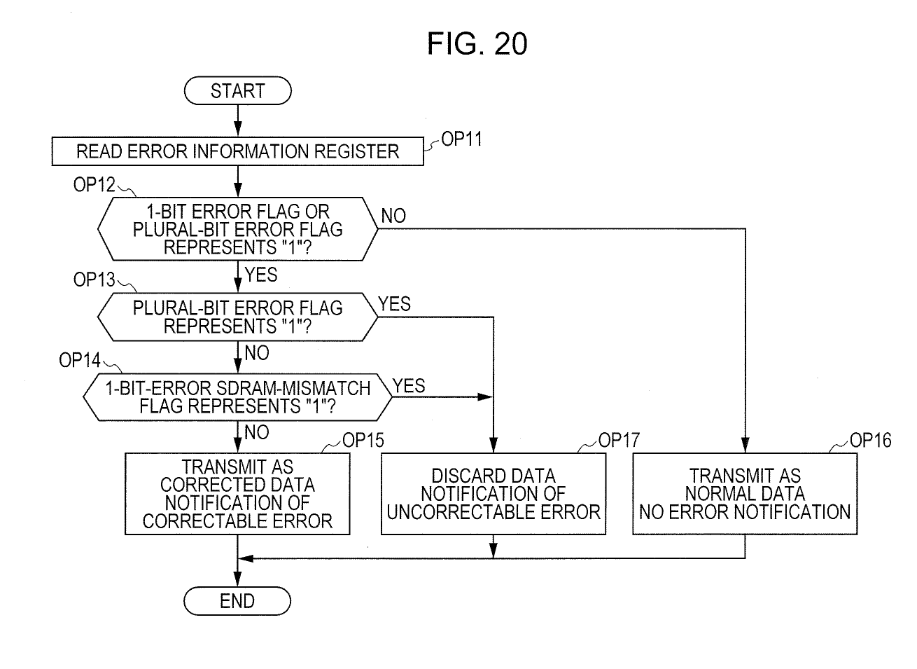

FIG. 20 is a diagram illustrating an error-type determination flow performed by the information processing apparatus according to the second embodiment. The process illustrated in FIG. 20 is executed by the error-type determination circuit 34-1g illustrated in FIG. 17. Note that, in FIG. 20, components the same as those described with reference to FIGS. 16 to 19 are denoted by reference numerals the same as those used in FIGS. 16 to 19, and descriptions thereof are omitted.

In FIG. 20, the error-type determination circuit 34-1g starts reading of the plural-bit-error detection flag information, the 1-bit-error detection flag information, and the 1-bit-error-SDRAM-number mismatch detection flag information which are stored in the error-information register 34-1f when a read valid signal is asserted by the error-information register 34-1f (in OP11). Subsequently, the error-type determination circuit 34-1g determines whether the 1-bit-error detection flag or the plural-bit-error detection flag is set to “1”, that is, whether a 1-bit-error or a plural-bit error has occurred at least once (in OP12). When it is determined that the 1-bit-error detection flag or the plural-bit-error detection flag is not an on state (that is, when the determination is negative in OP12), the error-type determination circuit 34-1g transmits an instruction for transmitting read data stored in the read buffer 33c as normal data which does not include an error to the data discarding circuit 35 (in OP16). The error-type determination circuit 34-1g does not transmit an error report to the CPU 15a and the control LSI 18 (in OP16).

When the 1-bit-error detection flag or the plural-bit-error detection flag is set to “1” (that is, the determination is affirmative in OP12), the error-type determination circuit 34-1g determines whether the plural-bit-error detection flag is “1” (in OP13). When it is determined that the plural-bit-error detection flag is set to “1” (that is, when the determination is affirmative in OP13), the error-type determination circuit 34-1g transmits an instruction for discarding the read data stored in the read buffer 33c to the data discarding circuit 35 (in OP17). The error-type determination circuit 34-1g notifies the CPU 15a and the control LSI 18 of a presence of an uncorrectable error in the read data stored in the read buffer 33c (in OP17).

When the plural-bit-error detection flag is not set to “1” (that is, the determination is negative in OP13), the error-type determination circuit 34-1g determines whether the 1-bit-error-SDRAM-number mismatch detection flag is set to “1” (in OP14). When the 1-bit-error-SDRAM-number mismatch detection flag is set to “1” (that is, the determination is affirmative in OP14), the error-type determination circuit 34-1g transmits an instruction for discarding the read data stored in the read buffer 33c to the data discarding circuit 35 (in OP17). The error-type determination circuit 34-1g notifies the CPU 15a and the control LSI 18 of a presence of an uncorrectable error in the read data stored in the read buffer 33c (in OP17).

When the 1-bit-error-SDRAM-number mismatch detection flag is not set to “1” (that is, the determination is negative in OP14), the error-type determination circuit 34-1g transmits an instruction for transmitting the read data stored in the read buffer 33c as a correction data to the data discarding circuit 35 (in OP15). The error-type determination circuit 34-1g notifies the CPU 15a and the control LSI 18 of a presence of an correctable error in the read data stored in the read buffer 33c (in OP15).

FIG. 21 is a principle diagram illustrating an operation of detecting a 1-bit error of read data performed by the information processing apparatus according to the second embodiment. Specifically, FIG. 21 is a principle diagram illustrating a case where a 1-bit error has occurred due to failure of a data line disposed on a substrate of the DIMM 21 and correctable errors are intermittently detected in reading in an 8-clock cycle. The information processing apparatus of the second embodiment stores a number of an SDRAM which includes error information including a type of error and an error bit. The error information illustrated in FIG. 21 is stored in the 1-bit-error-SDRAM-number storage register 34-1e-1, for example. As illustrated in FIG. 21, when 1-bit data included in a data block of 9 bytes stored in the read buffer 33c fails, the ECC check circuit 32 detects the 1-bit error as a correctable error. When the ECC check circuit 32 outputs information on a type of error and information on a position of an error bit, the error-SDRAM-number determination circuit 36 determines and outputs a number of an SDRAM including the error bit in accordance with the error-bit position information. In this case, information on a position of a 1-bit error represents an SDRAM number of error one of the SDRAMs 24-0 to 24-m-1, and therefore, results of error check of data 2 and data 4 are all “3” representing the position of the error SDRAM. Accordingly, when the results of the error check are compared with each other and it is determined that information on the SDRAM numbers coincide with each other, an error of a specific 1 bit included in the data block of 9 bytes is recognized. The error collating circuit 34-1 determines the error as a correctable error. Specifically, the error collating circuit 34-1 is a determination unit which determines, when a number of data including 1-bit errors detected by the ECC check circuit 32 serving as the error detection unit are included in a plurality of read data stored in the read buffer 33c and error-detection positions of the detected data coincide with one another, that a group of the plurality of data includes a correctable error.

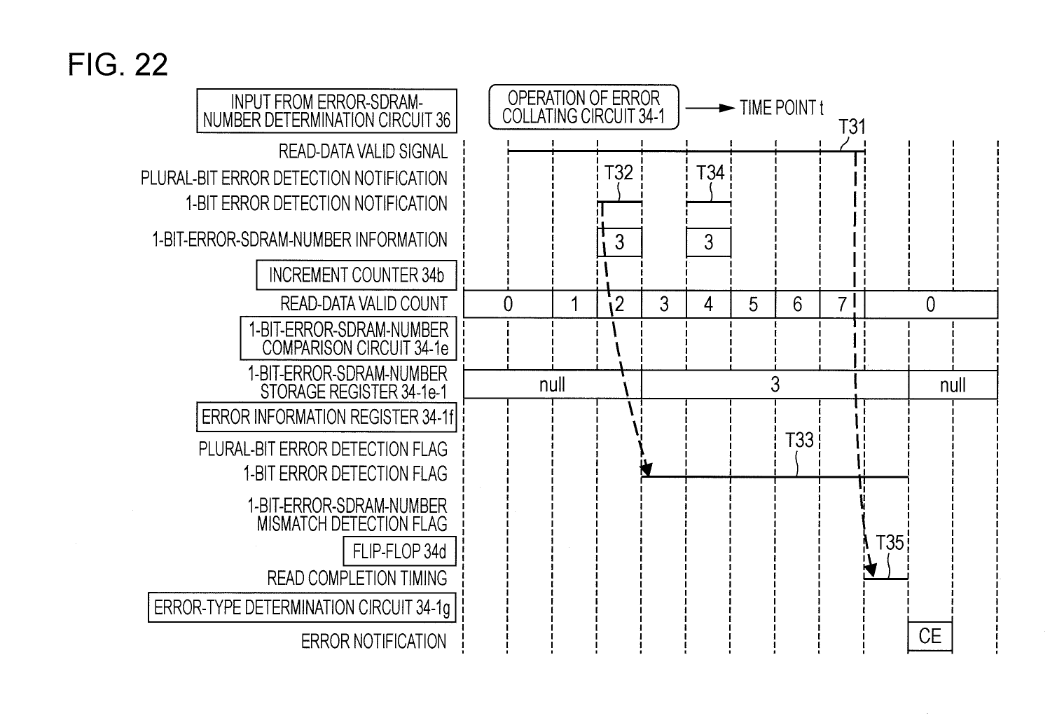

FIG. 22 is a time chart illustrating the operation of detecting a correctable error of read data performed by the error collating circuit 34-1.

As illustrated in FIG. 22, the AND circuit 34a receives a read-data valid signal from the error-SDRAM-number determination circuit 36 (in a time period T31). When receiving the read-data valid signal from the error-SDRAM-number determination circuit 36, the increment counter 34b increments a value of a counter by one for each cycle of a clock signal and outputs the value to the AND circuit 34a (in a time period T31).

The error collating circuit 34-1 receives a 1-bit-error detection notification and 1-bit-error SDRAM number information from the error-SDRAM-number determination circuit 36 in the third cycle in eight cycles of the read data (in a time period T32). Note that the supplied 1-bit-error SDRAM number information represents that a number of a 1-bit error SDRAM is “3”.

The error collating circuit 34-1 sets a 1-bit error detection flag of the error-information register 34-1f to “1” in accordance with the supplied 1-bit-error detection notification (at a time period T33).

The error collating circuit 34-1 receives a 1-bit-error detection notification and 1-bit-error SDRAM number information from the error-SDRAM-number determination circuit 36 in the fifth cycle in eight cycles of the read data (in a time period T34). Note that the supplied 1-bit-error SDRAM number information represents that a number of the 1-bit error SDRAM is “3”. In this case, the 1-bit-error SDRAM number detected in the third cycle and the 1-bit error SDRAM number detected in the fifth cycle are both “3”. Therefore, the error collating circuit 34-1 does not set the 1-bit-error-SDRAM-number mismatch detection flag of the error-information register 34-1f to “1”.

The AND circuit 34a asserts a read-data-reading-completion timing signal representing that reading of the read data from the DIMM 21 is completed when the value of the counter of the increment counter 34b represents 7. The flip-flop 34d receives the read-data-reading-completion timing signal supplied from the AND circuit 34a (in a time period T35). Thereafter, the error-type determination circuit 34-1g reads out the 1-bit-error detection flag information stored in the error-information register 34-1f. The error-type determination circuit 34-1g outputs error notification information representing that the error of the read data is a correctable error to the data discarding circuit 35, the CPU 15a, and the control LSI 18.

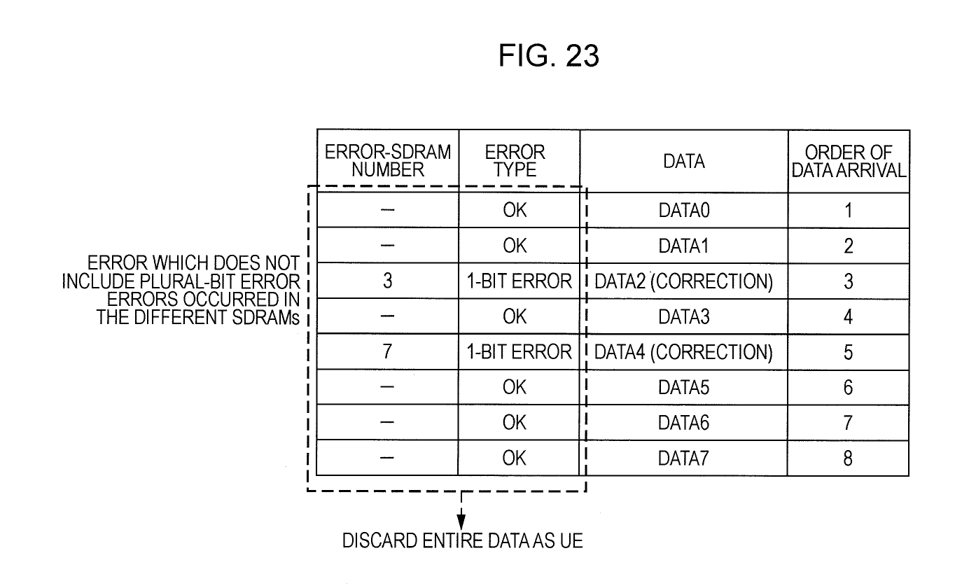

FIG. 23 is a principle diagram illustrating an operation of mistakenly detecting a correctable error of read data performed by the error collating circuit 34-1 included in the information processing apparatus according to the second embodiment. In FIG. 23, a case where errors in 3 bits or more intermittently occur in 9-byte data due to failure of an address line of the SDRAMs 24-0 to 24-m-1 in the reading operation in a 8-clock cycle and the ECC check circuit 32 mistakenly detects the errors as 1-bit errors is described as an example. As illustrated in FIG. 23, error SDRAM numbers of data 2 and data 4 are “3” and “7”, respectively. Therefore, when results of error check are compared with each other, the error SDRAM number information does not match with each other. Accordingly, it is likely that plural-bit errors are mistakenly detected as correctable errors. Therefore, the error collating circuit 34-1 of the second embodiment determines that false detection of errors is performed and the errors are corrected as uncorrectable errors. Specifically, the error collating circuit 34-1 is a determination unit which determines, when a number of data including 1-bit errors detected by the ECC check circuit 32 serving as the error detection unit are included in a plurality of read data stored in the read buffer 33c and the detected error-detection positions of the data are different from each other, that the plurality of data includes an uncorrectable error.

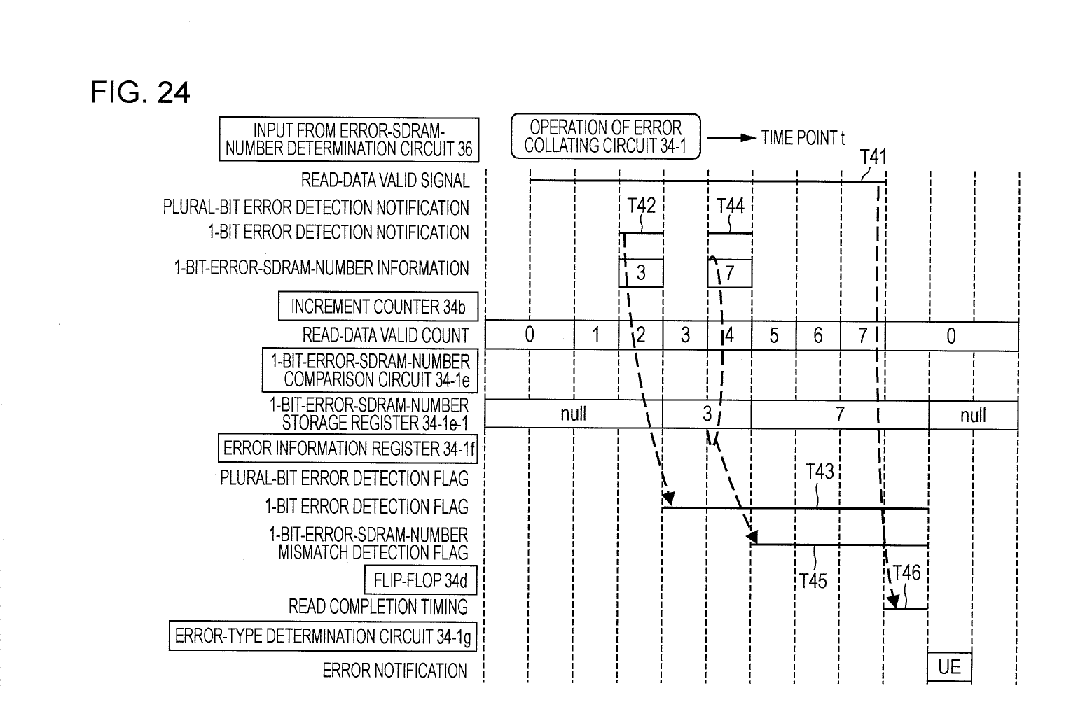

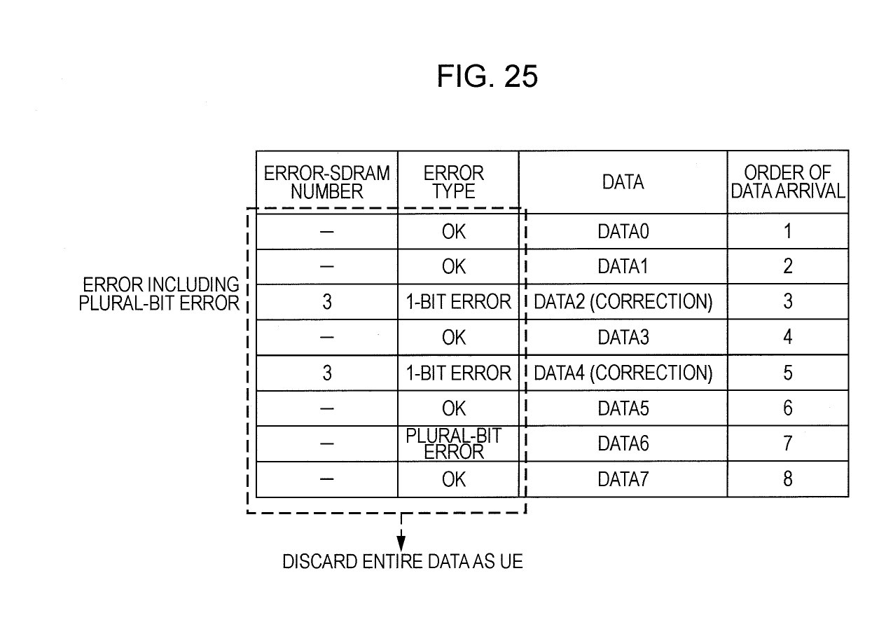

FIG. 24 is a time chart illustrating an operation of mistakenly detecting a correctable error of read data performed by the error collating circuit 34-1.

As illustrated in FIG. 24, the AND circuit 34a receives a read-data valid signal from the error-SDRAM-number determination circuit 36 (in a time period T41). When receiving the read-data valid signal from the error-SDRAM-number determination circuit 36, the increment counter 34b increments a value of the counter by one for each cycle of a clock signal and outputs the value to the AND circuit 34a (in the time period T41).

The error collating circuit 34-1 receives a 1-bit-error detection notification and 1-bit-error SDRAM number information from the error-SDRAM-number determination circuit 36 in the third cycle in eight cycles of the read data (in a time period T42). Note that the supplied 1-bit-error SDRAM number information represents that a number of the 1-bit error SDRAM is “3”.

The error collating circuit 34-1 sets the 1-bit error detection flag of the error-information register 34-1f to “1” in accordance with the supplied 1-bit-error detection notification (at a time period T43).

The error collating circuit 34-1 receives a 1-bit-error detection notification and 1-bit-error SDRAM number information from the error-SDRAM-number determination circuit 36 in the fifth cycle in eight cycles of the read data (in a time period T44). Note that the supplied 1-bit-error SDRAM number information represents that a number of the 1-bit error SDRAM is “7”. In this case, the 1-bit-error SDRAM number detected in the third cycle and the 1-bit error SDRAM number detected in the fifth cycle are different from each other. Therefore, the error collating circuit 34-1 sets the 1-bit-error-SDRAM-number mismatch detection flag of the error-information register 34-1f to “1” (in a time period T45).

The AND circuit 34a asserts a read-data-reading-completion timing signal representing that reading of the read data from the DIMM 21 is completed when the value of the counter of the increment counter 34b represents 7. The flip-flop 34d receives the read-data-reading-completion timing signal supplied from the AND circuit 34a (in a time period T46). Thereafter, the error-type determination circuit 34-1g reads out the 1-bit-error detection flag information and the 1-bit-error-SDRAM-number mismatch detection flag information which are stored in the error-information register 34-1f. The error-type determination circuit 34-1g outputs error notification information representing that the error of the read data is an uncorrectable error to the data discarding circuit 35, the CPU 15a, and the control LSI 18.

FIG. 25 is a principle diagram illustrating an operation of detecting an uncorrectable error of read data performed by the error collating circuit 34-1 included in the information processing apparatus according to the second embodiment. In FIG. 25, a case where errors in 2 bits or more intermittently occur in 9-byte data due to failure of an address line of the SDRAMs 24-0 to 24-m-1 in the reading operation in a 8-clock cycle and the ECC check circuit 32 detects a plural-bit error is described as an example. As illustrated in FIG. 25, 1-bit-error SDRAM numbers of data 2 and data 4 are “3” and data 6 includes a plural-bit error. In this case, it is apparent that errors occur in a plurality of bits in the DIMM 21 since the plural-bit error is detected, and accordingly, the error collating circuit 34-1 determines the error as an uncorrectable error.

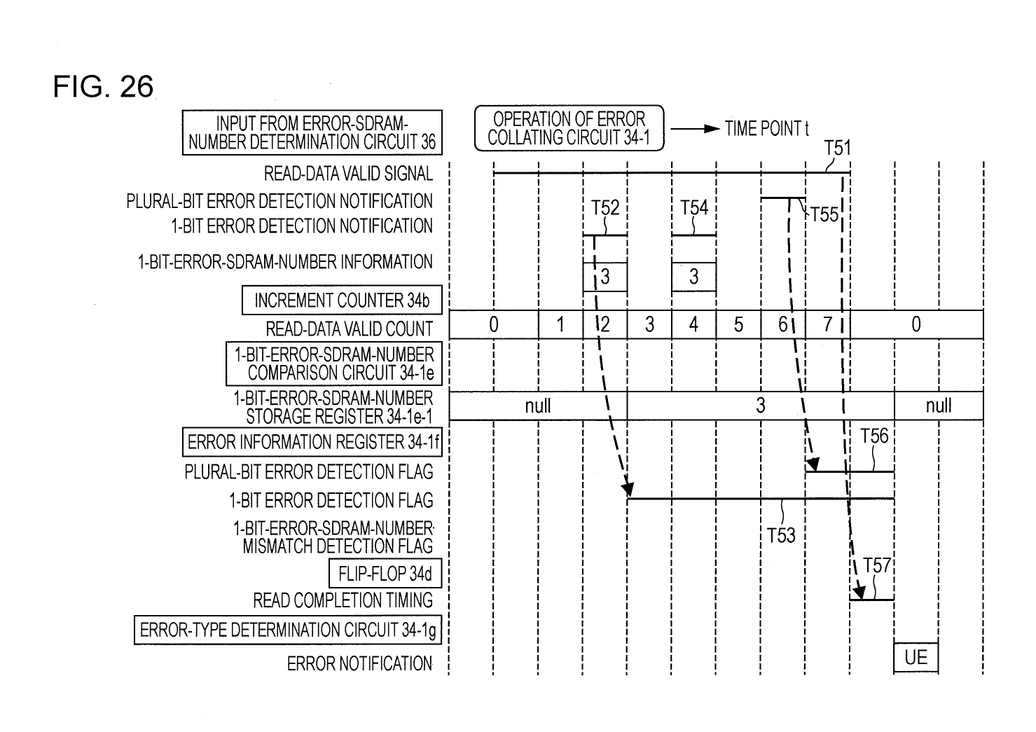

FIG. 26 is a time chart illustrating an operation of detecting an uncorrectable error of read data performed by the error collating circuit 34-1.

As illustrated in FIG. 26, the AND circuit 34a receives a read-data valid signal from the error-SDRAM-number determination circuit 36 (in a time period T51). When receiving the read-data valid signal from the error-SDRAM-number determination circuit 36, the increment counter 34b increments a value of the counter by one for each cycle of a clock signal and outputs the value to the AND circuit 34a (in a time period T51).

The error collating circuit 34-1 receives a 1-bit-error detection notification and 1-bit-error SDRAM number information from the error-SDRAM-number determination circuit 36 in the third cycle in eight cycles of the read data (in a time period T52). Note that the supplied 1-bit-error SDRAM number information represents that a number of the 1-bit error SDRAM is “3”.

The error collating circuit 34-1 sets the 1-bit error detection flag of the error-information register 34-1f to “1” in accordance with the supplied 1-bit-error detection notification (at a time period T53).

The error collating circuit 34-1 receives a 1-bit-error detection notification and 1-bit-error SDRAM number information from the error-SDRAM-number determination circuit 36 in the fifth cycle in eight cycles of the read data (in a time period T54). Note that the supplied 1-bit-error SDRAM number information represents that a number of the 1-bit error SDRAM is “3”. In this case, the 1-bit-error SDRAM number detected in the third cycle and the 1-bit error SDRAM number detected in the fifth cycle are the same as each other. Therefore, the error collating circuit 34-1 does not set the 1-bit-error-SDRAM-number mismatch detection flag of the error-information register 34-1f to “1”.

The error collating circuit 34-1 receives a plural-bit-error detection notification from error-SDRAM-number determination circuit 36 in the seventh cycle in the eight cycles of the read data (in a time period T55). The error collating circuit 34-1 sets the plural-bit-error detection notification of the error-information register 34-1f to “1” (in a time period T56).

The AND circuit 34a asserts a read-data-reading-completion timing signal representing that reading of the read data from the DIMM 21 is completed when the value of the counter of the increment counter 34b represents 7. The flip-flop 34d receives the read-data-reading-completion timing signal supplied from the AND circuit 34a (in a time period T57). Thereafter, the error-type determination circuit 34-1g reads out the 1-bit-error detection flag information and the plural-bit-error detection flag information which are stored in the error-information register 34-1f. The error-type determination circuit 34-1g outputs error notification information representing that the error of the read data is an uncorrectable error to the data discarding circuit 35, the CPU 15a, and the control LSI 18.

According to the technique disclosed in the second embodiment, the number of storage devices to be used may be reduced when compared with the memory controller 22 which stores error bits and the information processing apparatus according to the first embodiment. Failure of the DIMM 21 is mainly generated in a unit of SDRAM (SDRAMs 24-0 to 24-m-1). Therefore, by detecting error positions in the individual SDRAMs 24-0 to 24-m-1, supply of data to be discarded through the error check circuit is suppressed with high accuracy.

Note that, although a hamming code for 1-bit correction and 2-bit detection is described as an ECC code used to correct and detect an error in the first and second embodiments, the memory controllers and the information processing apparatuses of the first and second embodiments may be configured using another ECC code. For example, when an error correction code which performs error determination on data as a group of blocks each of which has 4 bits is used, a 1-block error is correctable but errors in 2 blocks or more are not correctable (refer to S. Kaneda and E. Fujiwara, “Single Byte Error Correcting-Double Byte Error Detecting Codes for Memory Systems”, IEEE Transactions on computers, Voc. C-31, No. 7, pp. 596-602, July 1982, for example).

When an S4EC-D4ED (Single 4 bit block Error Correction-Double 4 bit block Error Detection) code described in the example above is used, as with the case of the use of the hamming code, errors in 3 blocks or more in read data may be mistakenly determined as a 1-block error. Even when such a error correction code for 4-bit block correction and 8-bit block detection is used, positions of errors of data may be stored in an error collating circuit and the positions are compared with each other when reading performed by a DIMM is completed whereby a correctable error which is mistakenly detected and an uncorrectable error may be distinguished.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A memory controller which is connected to a memory module having an ECC (Error Check and Correction) function and which controls access to the memory module, the memory controller, comprising:
an error detection unit configured to detect an error bit and a position of the error bit by reading, from the memory module, information on codes of the ECCs corresponding to a plurality of read data read from the memory module;
a buffer configured to temporarily store the plurality of read data; and
a determination unit configured to determine, when the plurality of read data stored in the buffer include a number of data in which a correctable error is detected by the error detection unit and error detection positions of the detected data are the same as each other, that a correctable error is included in a group of the plurality of read data.

2. The memory controller according to claim 1,
wherein the determination unit determines, when the plurality of read data stored in the buffer include a number of data in which a correctable error is detected by the error detection unit and error detection positions of the detected data are different from each other, that an uncorrectable error is included in the group of the plurality of read data.

3. An information processing apparatus including a memory module having an ECC (Error Check and Correction) function and a memory controller which is connected to the memory module and which controls access to the memory module, the information processing apparatus, comprising:
an error detection unit configured to detect an error bit and a position of the error bit by reading, from the memory module, information on codes of the ECCs corresponding to a plurality of read data read from the memory module;
a buffer configured to temporarily store the plurality of read data; and
a determination unit configured to determine, when the plurality of read data stored in the buffer include a number of data in which a correctable error is detected by the error detection unit and error detection positions of the detected data are the same as each other, that a correctable error is included in a group of the plurality of read data.

4. The information processing apparatus according to claim 3,
wherein the determination unit determines, when the plurality of read data stored in the buffer include a number of data in which a correctable error is detected by the error detection unit and error detection positions of the detected data are different from each other, that an uncorrectable error is included in the group of the plurality of read data.

5. A method of controlling a memory controller which is connected to a memory module having an ECC (Error Check and Correction) function and which controls access to the memory module, the method comprising:
detecting an error block including a plurality of error bits and a position of the error block by reading, from the memory module, information on codes of the ECCs corresponding to a plurality of read data read out from the memory module;
storing the plurality of read data; and
determining, when the plurality of read data stored in the buffer include a number of data in which a correctable error is detected by the detecting and error detection positions of the detected data are the same as each other, that a correctable error is included in a group of the plurality of read data.

6. The method according to claim 5,
wherein the determining determines, when the plurality of read data stored include a number of data in which a correctable error is detected by the detecting and error detection positions of the detected data are different from each other, that an uncorrectable error is included in the group of the plurality of read data.
